(19) United States
(12) Patent Application Publication
(10) Pub. No.: US 2022/0292308 A1
(43) Pub. Date: Sep. 15, 2022

(54) SYSTEMS AND METHODS FOR TIME SERIES MODELING

(71) Applicant: DataRobot, Inc., Boston, MA (US)

(72) Inventors: Jillian Schwiep, Miami, FL (US); Viktor Kovryzhkin, Kyiv (UA); Matthew Nitzken, Boston, MA (US); Anatolii Stehnii, Lviv (UA)

(21) Appl. No.: 17/693,127

(22) Filed: Mar. 11, 2022

Related U.S. Application Data
(60) Provisional application No. 63/160,254, filed on Mar. 12, 2021.

(51) Int. Cl. G06K 9/62; G06N 20/00

(52) U.S. Cl. CPC G06K 9/6256; G06K 9/6232; G06K 9/6261; G06N 20/00

(57) ABSTRACT

Systems and methods of time series modeling is provided. A system identifies a first dataset that includes a plurality of time series having a plurality of characteristics. A first time series of the plurality of time series can include one or more characteristics of the plurality of characteristics that are different from characteristics of a second time series of the plurality of time series. The system selects, based at least in part on the plurality of characteristics, a plurality of models. The system trains, via machine learning, the plurality of models with the first dataset. The system generates a model based at least in part on a combination of the plurality of models. The system deploys the model to output one or more predictions responsive to a second dataset. The second dataset can be different from the first dataset and can have at least one of the plurality of characteristics.

### CROSS-REFERENCES TO RELATED APPLICATIONS

This application claims the benefit of priority under 35 U.S.C. § 119 to U.S. Provisional Patent Application No. 63/160,254, filed Mar. 12, 2021, which is hereby incorporated by reference herein in its entirety.

### TECHNICAL FIELD

The present disclosure generally relates to systems and methods for developing and implementing forecasting models for time series.

### SUMMARY

In general, the subject matter described herein relates to the development and use of machine learning models for making time series predictions. In one example, a set of training data for the models can include a plurality of time series having a variety of time series characteristics, such as seasonality, frequency content, minimum values, maximum values, and/or average values. The variety of characteristics among the time series in the dataset can make it difficult to use a single predictive model to make accurate predictions or forecasts for all the time series. Accordingly, in certain implementations, a plurality of predictive models (collectively referred to herein as a combined model) can be developed and implemented (e.g., trained using the training data) for the plurality of time series. A set of prediction data can then be provided to the plurality of predictive models, and the models can be used to make forecasts based on the prediction data.

In various examples, the time series in the training data and/or the prediction data can be clustered into a plurality of groups having common time series characteristics. For example, two or more time series in the training data that have similar time series characteristics (e.g., similar seasonalities and/or magnitudes) can be added to the same group. Additionally or alternatively, the training data and/or the prediction data can be provided with identifiers (e.g., provided by users) that can be used to form the groups and/or identify the time series that belong in each group. Each group in the plurality of groups can be assigned to a respective model from the plurality of predictive models.

While portions of this disclosure relate specifically to forecasting models for large scale sales and/or supply chain use cases, it is understood that the models described herein can be applied to a wide variety of other use cases. In general, the applicable use cases can involve time series have a variety of dynamics, volumes, seasonalities, frequency content, trends, or other time series characteristics. Forecasting such use cases with a single model can be inaccurate and/or technically challenging, as described herein.

In some instances, for example, it can be challenging to build forecasting models for sales and supply chain use cases in that scales while maintaining accurate predictions. Such technical challenges can have many per-category and/or per-product series of observations, and such series can be heterogeneous (e.g., many different data types, including numerical, categorical, and text) and/or exhibit a variety of behaviors. For example, two or more products can have vastly different seasonal patterns and/or scales/volumes and may use different data processing techniques (e.g., treatment of missing values, etc.). Data scientists can be presented with a trade-off between: (i) building many models (e.g., one for each product or product type or category) that can accurately predict time series for each product but are difficult to implement (e.g., due to challenges related to selecting, deploying, using and monitoring hundreds or thousands of models), or (ii) building a small set of models or a single model that is less accurate but easier to implement (e.g., a small set of models that can be assessed, deployed, and monitored with less effort). In practice, the small set of models or a single model can struggle to learn series-specific effects and/or scales and can have difficulty making accurate predictions across a wide variety of time series types or products. In one example, efforts to forecast sales for a dataset provided by one of the one of the largest retail stores in the USA were more accurate when separate models were trained for each level of hierarchy. The most accurate modeling approaches can utilize a combination of many different models (e.g., tens or hundreds of models).

Advantageously, the systems and methods of this technical solution can address technical problems associated with time series modeling for a variety of problems and challenges. The systems and methods are generally useful for time series forecasting that involves a large number or variety of heterogeneous data series. For example, a large multinational retail company may want to optimize its operations and financial planning. The company can use the systems and methods of this technical solution to: accurately forecast sales per category or per stock keeping unit (SKU) for financial planning; perform effective inventory management; forecast overstocks/out-of-stocks for each product/store; and optimize staffing and marketing. The systems and methods can provide a technological innovation capable of performing or facilitating the following tasks: ingesting a large dataset and producing accurate models; performing feature engineering and feature reduction; building and testing multiple models and choosing the most accurate models, while allowing data scientists and analysts to perform model evaluation and assessment; providing a single model and insights related to the model's accuracy for specific products and/or product categories; and/or deploying a combination of models for use as a single model (a combined model), such that users do not need to worry about splitting datasets and getting predictions using concrete or separate models for specific products/categories or other time series.

In one aspect, the subject matter of this disclosure relates to a computer-implemented method. The method includes: providing a training dataset including a first plurality of time series having a plurality of time series characteristics, at least one time series from the first plurality of time series having a unique combination of the time series characteristics; identifying a plurality of predictive models for the first plurality of time series based on the time series characteristics; training the plurality of predictive models using the training dataset to generate a combined model including the plurality of predictive models; providing a prediction dataset including a second plurality of time series corresponding to the first plurality of time series; and using the combined model to make predictions for the second plurality of time series.

In certain examples, the plurality of time series characteristics can include seasonality, frequency content, average target values, maximum target values, minimum target values, a number of zero values, or any combination thereof. Identifying the plurality of predictive models can include mapping each time series in the first plurality of time series to at least one model in the plurality of predictive models. Mapping each time series can include: clustering the time series in the first plurality of time series into a plurality of groups, wherein each group in the plurality of groups includes common or similar characteristics from the time series characteristics; and assigning each group to a respective model from the plurality of predictive models. Using the plurality of predictive models can include mapping each time series in the second plurality of time series to at least one model in the plurality of predictive models.

An aspect of this technical solution is directed to a system. The system can include one or more processors, coupled to memory. The one or more processors can identify a first dataset that includes a plurality of time series having a plurality of characteristics. A first time series of the plurality of time series can include one or more characteristics of the plurality of characteristics that are different from characteristics of a second time series of the plurality of time series. The one or more processors can select, based at least in part on the plurality of characteristics, a plurality of models. The one or more processors can train, via machine learning, the plurality of models with the first dataset. The one or more processors can generate a model based at least in part on a combination of the plurality of models. The one or more processors can deploy the model to output one or more predictions responsive to a second dataset. The second dataset can be different from the first dataset and can have at least one of the plurality of characteristics.

The one or more processors can determine that multiple rows in the first dataset comprise a same timestamp. The one or more processors can provide, responsive to the determination, a prompt via a graphical user interface displayed on a display device coupled to a computing device. The one or more processors can receive an indication that the first dataset comprises more than one time series. The one or more processors can receive the indication via the prompt from the computing device. The one or more processors can determine to select the plurality of models based at least in part on the indication received from the computing device.

The one or more processors can provide, for display via a graphical user interface presented on a display device coupled to a computing device, a prompt to split the first dataset by segments. The one or more processors can receive, via the graphical user interface from the computing device, an indication to split the first dataset by segments. The one or more processors can split, responsive to the indication, the first dataset into segments.

The one or more processors can provide a user interface element to adjust at least one of a first window used to derive one or more features from the first dataset or a second window over which to predict values for the one or more features. The oen or more processors can provide the user interface element via a graphical user interface presented by a display device of a computing device. The one or more processors can provide, via the graphical user interface, an indication of a forecast point at or between the first window and the second window. The one or more processors can identify a blind history gap between the first window and the forecast point presented via the graphical user interface. The one or more processors can provide an indication via the graphical user interface of the blind history gap. The one or more processors can identify, based at least on the forecast point and the second window, a gap for which the model is unable to make predictions.

The one or more processors can provide, for presentation by a graphical user interface via a display device coupled to a computing device, a user interface element to select a configuration for a backtest. The one or more processors can receive, via the user interface element, a selection of the configuration for the backtest. The one or more processors can provide, for presentation by the graphical user interface, an indication of at least one of a validation portion for the backtest, a primary training data portion for the backtest, a gap for the backtest, or a holdout portion for the backtest.

The one or more processors can provide, for presentation by a graphical user interface via a display device coupled to a computing device, a user interface element to input a calendar of events to generate a feature for the plurality of time series. The one or more processors can receive, via the user interface element, the calendar of events. The one or more processors can derive one or more features of the first dataset using the calendar of events.

The plurality of characteristics can include at least one of seasonality, frequency content, average target values, maximum target values, minimum target values, or a number of zero values. The one or more processors can map each time series in the plurality of time series to at least one model in the plurality of models to select the plurality of models. The one or more processors can cluster the time series in the plurality of time series into a plurality of groups. Each group in the plurality of groups comprises common or similar characteristics from the characteristics. The one or more processors can assign each group to a respective model from the plurality of models to select the plurality of models.

An aspect of this technical solution is directed to a method. The method can be performed by one or more processors, coupled to memory. The method can include the one or more processors identifying a first dataset with a plurality of time series having a plurality of characteristics. A first time series of the plurality of time series can include one or more characteristics of the plurality of characteristics that are different from characteristics of a second time series of the plurality of time series. The method can include the one or more processors selecting, based at least in part on the plurality of characteristics, a plurality of models. The method can include the one or more processors training, via machine learning, the plurality of models with the first dataset. The method can include the one or more processors generating a model based at least in part on a combination of the plurality of models. The method can include the one or more processors deploying the model to output one or more predictions responsive to a second dataset. The second dataset can be different from the first dataset and have at least one of the plurality of characteristics.

An aspect of this technical solution is directed to a non-transitory computer-readable medium storing processor executable instructions that, when executed by one or more processors, cause the one or more processors to perform one or more actions. The computer-readable medium can include instructions that cause the one or more processors to identify a first dataset comprising a plurality of time series having a plurality of characteristics. A first time series of the plurality of time series can include one or more characteristics of the plurality of characteristics that are different from characteristics of a second time series of the plurality of time series. The computer-readable medium can include instructions that cause the one or more processors to select, based at least in part on the plurality of characteristics, a plurality of models. The computer-readable medium can include instructions that cause the one or more processors to train, via machine learning, the plurality of models with the first dataset. The computer-readable medium can include instructions that cause the one or more processors to generate a model based at least in part on a combination of the plurality of models. The computer-readable medium can include instructions that cause the one or more processors to deploy the model to output one or more predictions responsive to a second dataset. The second dataset can be different from the first dataset and have at least one of the plurality of characteristics.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system for time series modeling.

FIG. 2 depicts an example graphical user interface provided by the system.

FIG. 3 depicts an example plot of a trend for a search query.

FIGS. 4-38 depict example graphical user interfaces provided by the system.

FIG. 39 depicts an example computing processing system.

FIG. 40 depicts an example method for time series modeling.

### DETAILED DESCRIPTION

The figures (FIGS.) and the following description relate to embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

“Machine learning” generally refers to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. For example, a feature can be the price of a house. As a further example, a feature can be a shape extracted from an image of the house. In some cases, a feature of a data sample is a description of (or other information regarding) an entity represented by or associated with the data sample. A value of a feature may be a measurement of the corresponding property of an entity or an instance of information regarding an entity. For instance, in the above example in which a feature is the price of a house, a value of the ‘price’ feature can be $215,000. In some cases, a value of a feature can indicate a missing value (e.g., no value). For instance, in the above example in which a feature is the price of a house, the value of the feature may be ‘NULL’, indicating that the price of the house is missing.

Features can also have data types. For instance, a feature can have an image data type, a numerical data type, a text data type (e.g., a structured text data type or an unstructured (“free”) text data type), a categorical data type, or any other suitable data type. In the above example, the feature of a shape extracted from an image of the house can be of an image data type. In general, a feature's data type is categorical if the set of values that can be assigned to the feature is finite.

As used herein, “time-series data” may refer to data collected at different points in time. For example, in a time-series data set, each data sample may include the values of one or more variables sampled at a particular time. In some embodiments, the times corresponding to the data samples are stored within the data samples (e.g., as variable values) or stored as metadata associated with the data set. In some embodiments, the data samples within a time-series data set are ordered chronologically. In some embodiments, the time intervals between successive data samples in a chronologically-ordered time-series data set are substantially uniform.

Time-series data may be useful for tracking and inferring changes in the data set over time. In some cases, a time-series data analytics model (or “time-series model”) may be trained and used to predict the values of a target Z at time t and optionally times t+1, . . . , t+i, given observations of Z at times before t and optionally observations of other predictor variables P at times before t. For time-series data analytics problems, the objective is generally to predict future values of the target(s) as a function of prior observations of all features, including the targets themselves.

As used herein, “spatial data” may refer to data relating to the location, shape, and/or geometry of one or more spatial objects. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment).

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

Data (e.g., variables, features, etc.) having certain data types, including data of the numerical, categorical, or time-series data types, are generally organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “data analytics model” may refer to any suitable model artifact generated by the process of using a machine learning algorithm to fit a model to a specific training data set. The terms “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

As used herein, a “modeling blueprint” (or “blueprint”) refers to a computer-executable set of pre-processing operations, model-building operations, and postprocessing operations to be performed to develop a model based on the input data. Blueprints may be generated “on-the-fly” based on any suitable information including, without limitation, the size of the user data, features types, feature distributions, etc. Blueprints may be capable of jointly using multiple (e.g., all) data types, thereby allowing the model to learn the associations between image features, as well as between image and non-image features.

In certain examples, “seasonality” can refer to variations in time series data that repeat at periodic intervals, such as each week, each month, each quarter, or each year. For example, a time series having a weekly seasonality may exhibit variations that repeat substantially each week, over time.

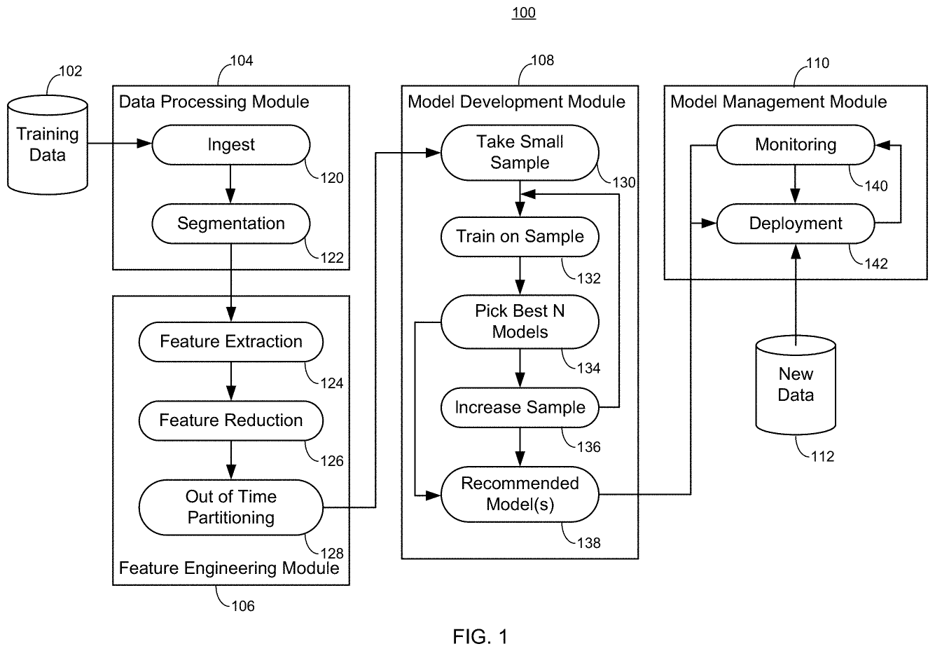

Referring to FIG. 1, in certain examples, the systems and methods described herein provide a complete technological solution for a large-scale data science workflow that includes several independent modules or components for data processing and exploration, feature engineering and reduction, model development and selection, and model deployment and monitoring. In brief overview, the system 100 can include, interface, access, or otherwise use a data processing module 104. The data processing module 104 can be provided that ingests training data 102 (e.g., from one or more files and/or databases) and performs data processing and/or segmentation. Training data 102 can be referred to as first data or a first dataset. The system 100 can include, interface, access, or otherwise use a feature engineering module 106. The feature engineering module 106 can receive the processed/segmented data and perform feature engineering, feature reduction, and/or data partitioning. The system 100 can include, interface, access, or otherwise use a model development module 108. The features and partitioned data can be provided to the model development module 108 that develops and trains one or more predictive models. The system 100 can include, interface, access, or otherwise use a model management module 110. The model management module 110 can deploy the models for end users and can monitor model performance and output model results. The deployed models can receive new data 112 (prediction data) and make time series predictions based on the new data. New data 112 can be referred to as second data or a second dataset. Once the training data 102 and/or new data 112 is received by the system (e.g., fed over an API), the data can be ingested and processed automatically.

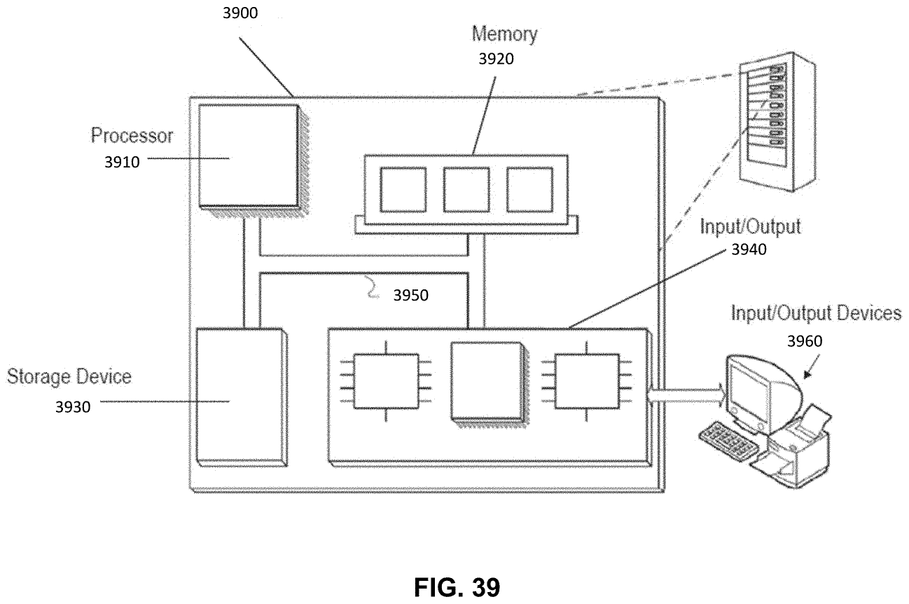

The data processing module 104, feature engineering module 106, model development module 108, and model management module 110 can each include one or more hardware or software components. The data processing module 104, feature engineering module 106, model development module 108, and model management module 110 can include or use one or more component or functionality of processing system 3900 depicted in FIG. 39, including, for example, one or more processors 3910, memory 3920, or storage device 3930.

Thus, the system 100 can identify a first dataset that includes multiple time series. The first dataset can include multiple characteristics. The multiple time series can include a first time series and a second time series. The first time series can include one or more characteristics that are different from characteristics of the second time series. The system 100 can select, based at least in part on the characteristics, multiple models. The system 100 can train, via machine learning, the models with the first dataset. The system 100 can generate a model based at least in part on a combination of the multiple models. The system 100 can deploy the model to output one or more predictions responsive to a second or new dataset. The second data set can be different from the first dataset and have at least one of the characteristics.

### Data Ingestion and Segmentation

The data processing module 104 can ingest and segment large-scale time series data. The system 100 can configure time series problems in multiple ways once the data has been ingested. For example, the system 100 can treat a time series problem as a single time series problem (e.g., with a single time series or type of time series) or a multiple time series problem (e.g., with multiple time series having a variety of characteristics). When a user uploads a dataset, the data processing module 104 can detect whether the dataset contains a single or multiple time series, and/or can detect any columns in the dataset that can be split into multiple time series. In some instances, for example, the data processing module 104 can determine that the dataset has multiple time series that have different time series characteristics (e.g., seasonality and/or magnitudes). The data processing module 104 can attempt to group each time series into one or more groups according to the characteristics. For example, a clustering approach (e.g., k-means clustering) can be used to cluster time series into respective groups, such that each time series in a group has a similar set of time series characteristics.

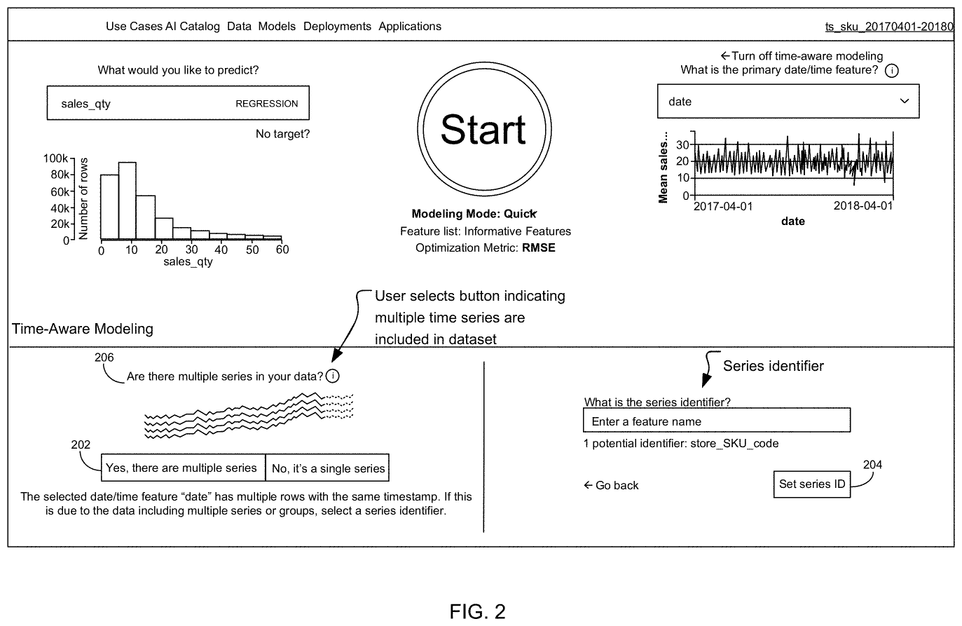

FIG. 2 is a screenshot of an example graphical user interface illustrating the data ingestion and segmentation capability. In one example, an ingested dataset can include one or more series identifiers (IDs) that identify one or more time series in the dataset. Additionally or alternatively, the data processing module 104 can determine whether data is regularly spaced over time (e.g., all observations appear at regularly spaced time steps). A regularly spaced time series can be or include, for example, a series in which each observation appears at the same time unit, such as every hour, every day, or every week. The data processing module 104 can accommodate series that have semi-regular spacing, such as time series that have inconsistent time units and/or occasional spacing errors. This can be useful with weekly data, for example, when observations may be recorded on different days of week, depending on the week. In such instances, the spacing may vary between 1 and 7 days and the dataset can still be detected or processed as though the dataset has regular spacing. For example, time values can be adjusted to make the spacing regular. Additionally or alternatively, interpolation can be performed to adjust variable values to reflect a uniform spacing.

By contrast, for non-regular datasets, the data processing module 104 can treat a dataset as an irregularly spaced single series or a regularly spaced multi series. FIG. 2 depicts an example in which the data processing module 104 has determined that a time series is not a regularly spaced single series dataset, because a user is being asked to choose a series identifier 204. A series identifier can be used to indicate that a dataset includes multiple time series problems (e.g., multiple time series or multiple time series having different time series characteristics). Additionally or alternatively, a user can select a button 202 indicating that a dataset includes multiple time series.

For example, the system 100 can determine that multiple rows in the first dataset comprise a same timestamp. The system 100 can provide, responsive to the determination, a prompt 206 via a graphical user interface displayed on a display device coupled to a computing device. The system 100 can receive, via the prompt 206 from the computing device, an indication that the first dataset comprises more than one time series. For example, the user can select button 202 to indicate that there are multiple series. The system 100 can determine to select the plurality of models based at least in part on the indication received from the computing device.

In some instances, for example, the data processing module 104 can determine that a dataset should be split into multiple segments (e.g., multiple time series or multiple time series problems), in a process referred to as segmentation. This can be useful for large-scale retail and demand forecasting problems or similar problems where a dataset includes several time series that have significantly different characteristics, for example, in terms of seasonality (e.g., weekly, monthly, or annual variations), trend, velocity, magnitude, or other characteristics. For example, a time series for a food product (e.g., milk or sugar) that is sold regularly and has a relatively low unit price can have different characteristics and/or different modeling requirements (e.g., use a different model), compared to a time series for a different product (e.g., a laptop computer or a gaming station) that is sold less regularly and has a higher unit price.

For example, the system 100 can provide, for display via a graphical user interface presented on a display device coupled to a computing device, a prompt 406 to split the first dataset by segments. The system 100 can receive, via the graphical user interface from the computing device, an indication to split the first dataset by segments. For example, the system 100 can receive the indication via a selection of button 402. The system 100 can split, responsive to the indication, the first dataset into segments.

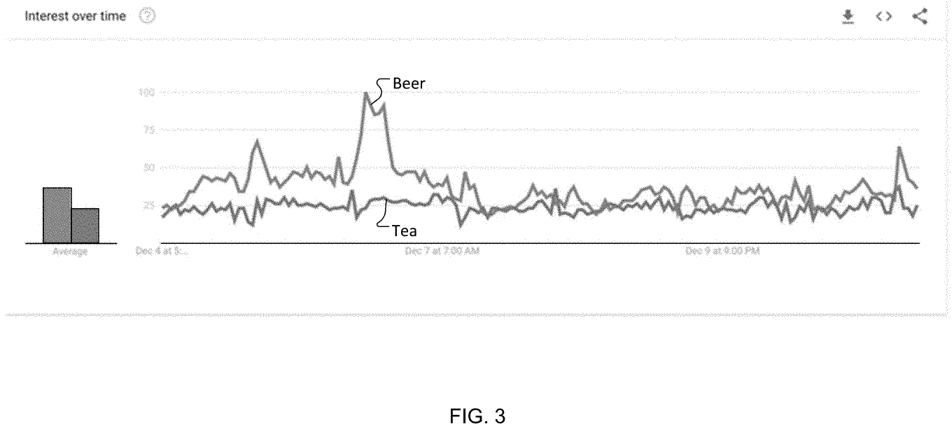

Additionally or alternatively, differences between such products or time series can be expressed in terms of seasonality (e.g., of single SKU sales). For example, FIG. 3 is a plot of a search engine trend for a query “buy beer” vs. “buy tea.” Unlike the buy tea curve, the buy beer curve has obvious spikes on the 5th and 6th of December, which correspond to Saturday and Sunday, respectively. In other words, beer sales may spike on weekends while tea sales may be relatively constant all week. Given the different characteristics for such time series (e.g., in terms of frequency content and/or magnitudes), it can be difficult to make accurate predictions for such time series using a single model.

One reason for such difficulty can relate to feature engineering. For example, an individual series (e.g., for a single product) in a set of multiple time series (e.g., for different products) may need a unique seasonality handling (e.g., due to different seasonality periods or frequencies) and/or trend handling (e.g., a linear trend vs. a logistic trend). Another reason for the difficulty of developing a model for a variety of time series is that the model may try to learn each datapoint as accurately as it can, across multiple time series. The resulting model may learn an average effect rather than learning each individual series correctly.

Advantageously, the data processing module 104 can solve this accuracy problem by segmenting time series data based on various characteristics (e.g., seasonality) and treating the data as a set of smaller subproblems. The data processing module 104 can allow users to specify the segmentation (e.g., choose which time series can be grouped together for a single model) and/or the data processing module 104 can perform such segmentation automatically. In some instances, for example, the data processing module 104 can analyze a plurality of time series in a dataset and sort or cluster each time series into one or more categories or groups. For example, time series that are similar in terms of seasonality, trends, velocities (e.g., rates of change), magnitudes or other characteristics can be segmented into respective groups. A different model or set of models can then be developed and used for each group. A clustering technique (e.g., k-means or mean-shift clustering) can be used to segment the time series into the respective groups.

In various examples, when time series in a dataset are segmented into two or more groups or segments, the data processing module 104 can implement a “segmented project” for the dataset. Segmented project can be or include a project where segments of data (e.g., including one or more time series) in a dataset are modeled separately. For example, one or more models can be trained, selected, and used to make predictions for each segment or chunk of data. In certain examples, the multiple models can be referred to collectively as a “combined model,” as described herein.

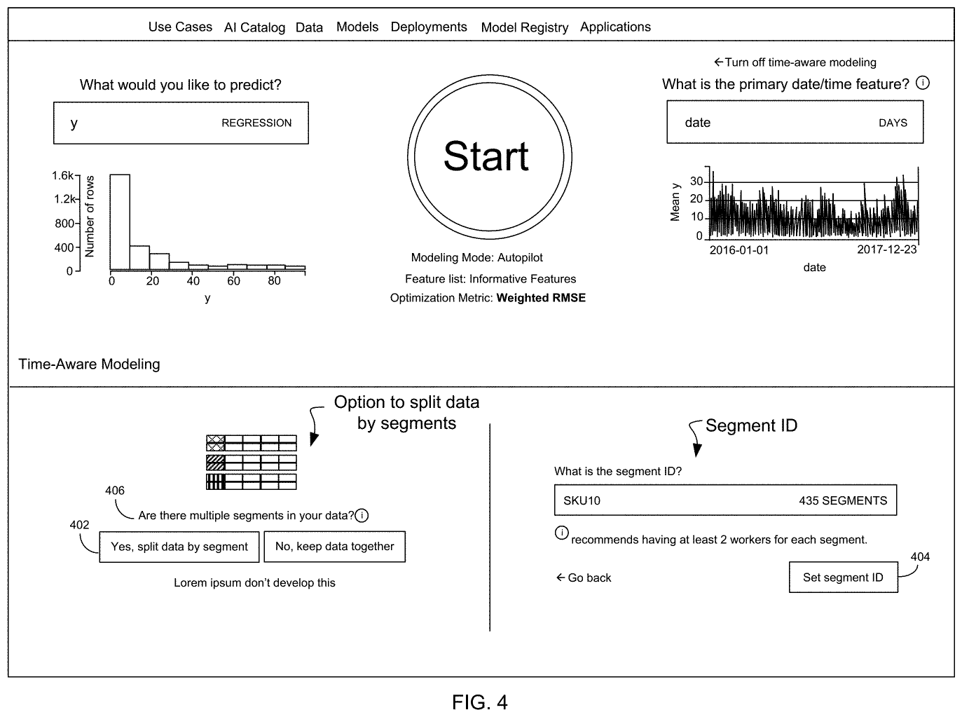

FIG. 4 is a screenshot showing an example graphical user interface for segmentation based on an existing column or segment ID 404. Additionally or alternatively, a user can select a button 402 indicating that that there are multiple segments (e.g., time series or groups of time series) present in a dataset.

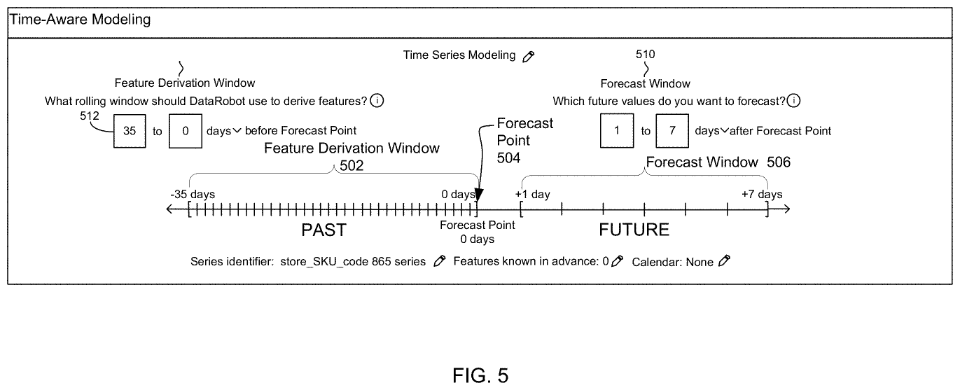

In certain examples, a user can configure the problem or experiment as a time series problem, for example, by specifying a feature derivation window 502 (FDW) and/or a forecast window 506 (FW), according to modeling requirements. In general, the feature derivation window 502 can be a period of time before a forecast point 504 (a time at which a forecast is made) within which features can be derived for the time series. The forecast window can be a period of time after the forecast point 504 for which the model is used to make predictions or forecasts. Smart defaults for feature derivation window and/or the forecast window can be provided to the user based on the dataset. For example, FIG. 5 illustrates a graphical user interface that allows the user to specify the feature derivation window 502 and the forecast window 506.

For example, the system 100 can provide, via a graphical user interface presented by a display device of a computing device, a user interface element 508 to adjust at least one of a first window used to derive one or more features from the first dataset or a second window over which to predict values for the one or more features. The user interface element 508 can include input text boxes 512 in which a user can input a number of days before a forecast point 504 to use for the feature derivation window 502 (e.g., a first window). The system 100 can provide, via the graphical user interface, an indication of a forecast point 504 at or between the feature derivation window 502 (e.g., a first window) and the forecast window 506 (e.g., a second window). The system 100 can provide a forecast window user interface element 510 with input text boxes through which a user can adjust the forecast window 506.

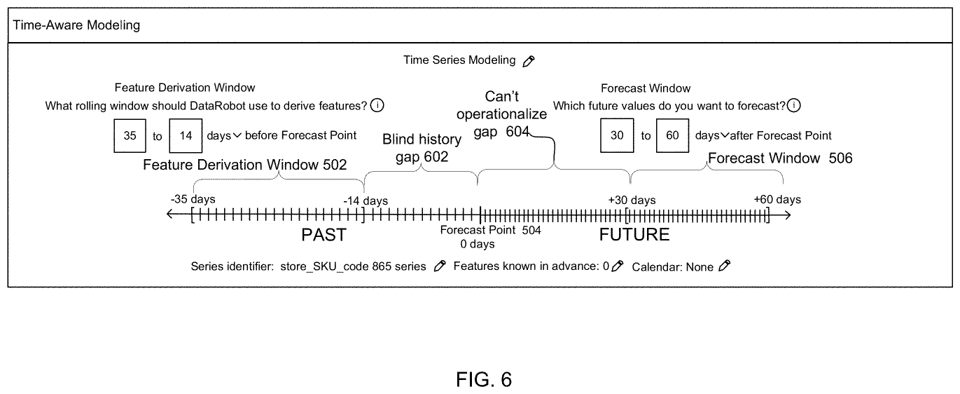

In various examples, the feature derivation window 502 and forecast window 506 can be configured according to one or more or modeling requirements (e.g., the model may not be able to use historical data up to a forecast point, such as now or today). This might be due to engineering ETL (extract, transform, load) pipelines that can prevent data for the previous couple of weeks from being available today, such that the model cannot use such data to make forecasts for tomorrow. This gap in available data can be referred to as a “blind history gap” 602. Another consideration is that the business might not be interested in obtaining a forecast for immediately after the forecast point 504 (e.g., there may be no point today to predict sales for tomorrow). The business may need to forecast demand over the next couple of months, so that a supply chain can be optimized over a middle-to-long term. Such a gap can be referred to as a “can't operationalize gap” 604. FIG. 6 is a screenshot of an example graphical user interface for configuring time aware modeling with the “blind history gap” 602 (a gap in the past data) and the “can't operationalize gap” 604 (a gap in future forecasts). The figure illustrates how such parameters can be defined or controlled for time series modeling efforts.

For example, the system 100 can identify a blind history gap 602 between the forecast window 502 (e.g., first window) and the forecast point 504 presented via the graphical user interface. The system 100 can provide an indication 602 via the graphical user interface of the blind history gap 602. The system 100 can identify, based at least on the forecast point 504 and the forecast window 506 (e.g., second window), a gap 604 for which the model is unable to make predictions (e.g., a can't operational gap).

The systems and methods described herein can also be used to solve time series cross validation (CV). In general, time series problems cannot be cross-validated as easily as traditional machine learning models. Traditional cross-validation can involve splitting training data into N folds randomly, and running N experiments that use N−1 folds for training and 1 fold for validation. A different fold can be used for validation in each experiment so that each fold is used for validation once, after all experiments have been performed. The scores can then be averaged and a resulting CV score can be used as a measure of model performance. The same approach is generally not used for time series problems, however, because shuffling data into different folds could lead to training on future data to predict the past.

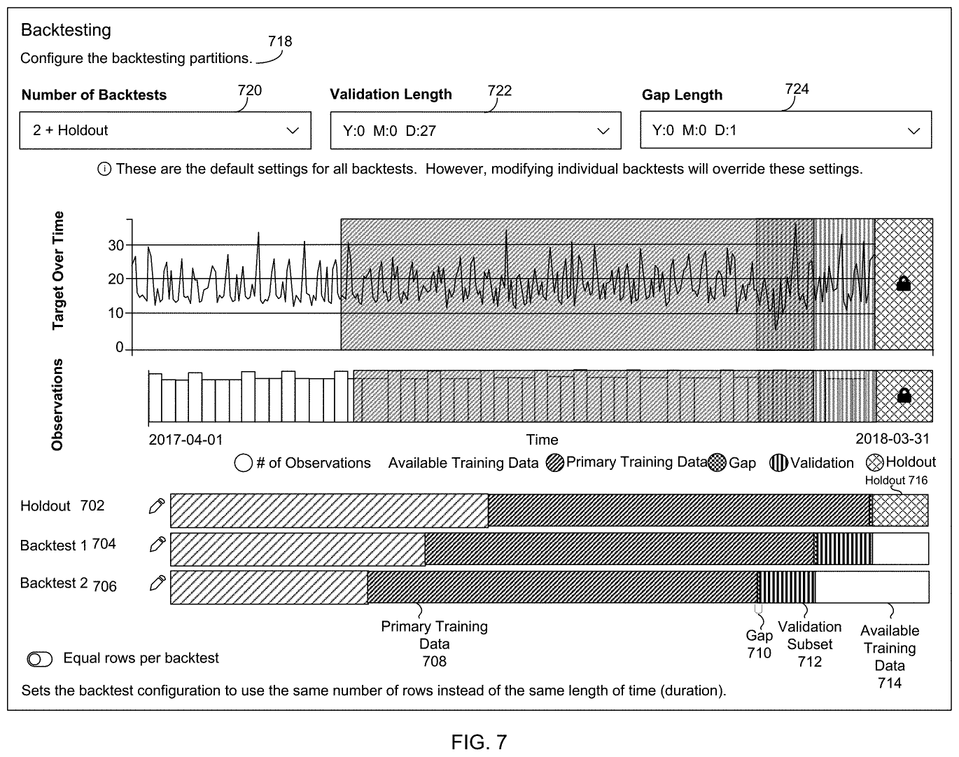

In various examples, the systems and methods described herein solve the cross validation problem by performing a walk backward out of time validation or backtest. In general, backtesting can involve using data to make model predictions for events that have already occurred. Essentially, the model can be provided with inputs that would have been available at a previous time and the model can make predictions for events that occurred after the previous time. To perform backtesting, training data can be split into individual backtests, with the number of backtests being determined based on the dataset. For example, FIG. 7 is a screenshot of an example graphical user interface showing a backtesting cross-validation. The GUI depicts a hold out data set 702, a backtest 1 dataset 704, and a backtest 2 data set 706. Validation subsets can be created starting from a first backtest 704 (“Backtest 1”) and walking backward such that backtests do not intersect. A holdout 702 subset of data can be set up forward from the first backtest 704 and can be most recent in terms of the dataset timeline. This can allow the model to be evaluated on the most recent data.

As illustrated in the graphical user interface (“GUI”) depicted in FIG. 7, for each of the data sets 702, 704, and 706, the system can depict a portion that corresponds to the primary training data 708, a portion that corresponds to a gap 710 (e.g., a blind history gap), a portion that corresponds to a validation subset 712, and portions for which there is available training data 714. The GUI can depict for the holdout data set 702 a portion that corresponds to the holdout data set 716. For example, the system 100 can provide, for presentation by a graphical user interface via a display device coupled to a computing device, a user interface element 718 to select a configuration for a backtest. The user interface element 718 can include one or more drop down menus or input text boxes to provide input, such as an input user interface element for number of backtests 720, an input user interface element for validation length 722, or an input user interface element for gap length 724. The system 100 can receive, via the user interface element 718, a selection of the configuration for the backtest. The system 100 can provide, for presentation by the graphical user interface, an indication of at least one of a validation portion 712 for the backtest, a primary training data portion 708 for the backtest, a gap 710 for the backtest, or a holdout portion 716 for the backtest.

Additionally or alternatively, partitioning of data for backtesting can be calculated in an asynchronous fashion or based on actual data in addition to or instead of heuristics. For example, data in a signal can be analyzed to determine an “energy” or activity level present in the signal over time. This can be done, for example, performing a downsampling based on how the data is structured. Once the energy has been computed, default partitions can be created and the system can confirm that each backtest includes at least some energy (e.g., in the validation subset). In other words, partitions can be created so a validation subset includes a certain amount of energy (e.g., amplitudes and/or frequency content in the signal), rather than having little or no energy (e.g., a constant magnitude or all zeros). This can avoid the creation of backtests where the model is used to make predictions for validation subsets where nothing of interest occurred (e.g., no sales during the validation subset). For example, a signal can have many interesting events (high energy) that occurred early in the time series and then very little activity (low energy) near the end of the time series. It is generally preferable to backtest the model on portions of the signal where interesting events or energy are located. In some instances, for example, if the system finds there is insufficient energy for a backtest, then sizes of backtests can be expanded or adjusted and/or or additional backtests can be added, in an effort to capture more energy. The approach can also be used to generate errors and warnings, to let the user know when there is insufficient energy or that data is flatlined in certain areas, such as the holdout. Advantageously, this backtesting approach can remove the need to guess a number of rows to consider for backtesting and/or the need to rely on EDA (exploratory data analysis) histograms. This can avoid or eliminate a wide range of edge case errors that can otherwise occur. In various examples, this backtesting scheme can be used for segmented projects, which can be split into multiple smaller datasets or problems having separate timelines, models, and/or backtesting intervals or schemes.

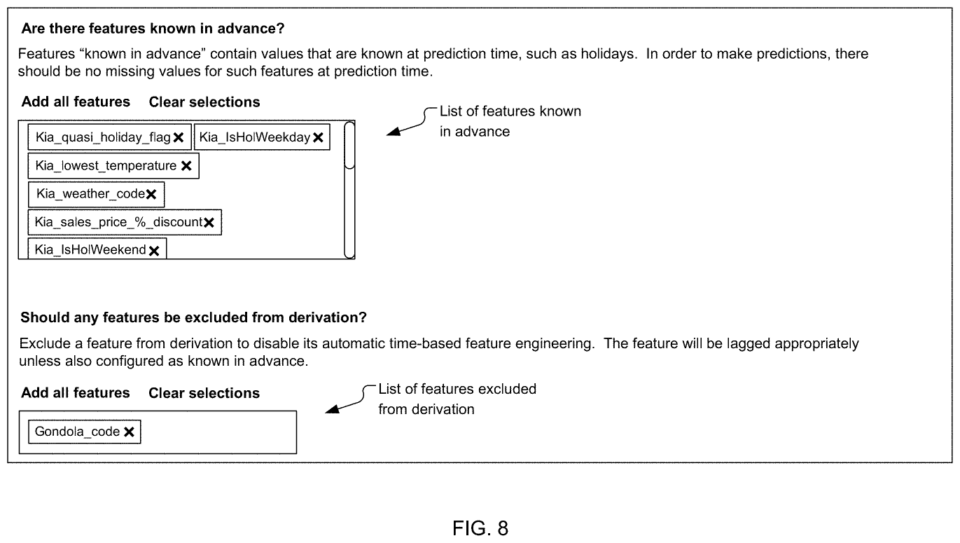

In various implementations, the systems and methods described herein can provide special treatment to features known in advance (e.g., holidays or other features known at prediction time) and/or other features that are excluded from the feature engineering process (e.g., to disable automatic time-based feature engineering). Known in advance features as well as features excluded from derivation are discussed in greater detail below (e.g., in the Feature Engineering and Data Partitioning subsection). A graphical user interface for configuring features that are known in advance and/or excluded from derivation is shown in FIG. 8.

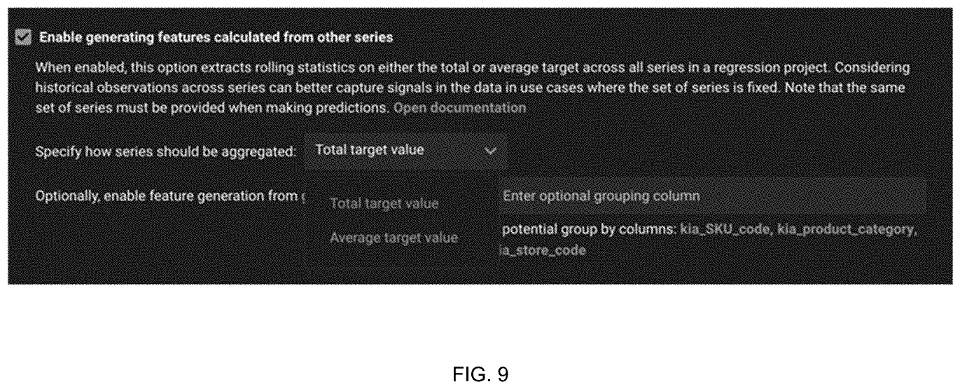

FIG. 9 is a screenshot of an example graphical user interface that allows user to enable the generation of features calculated from other series. When enabled, rolling statistics can be extracted on either a total or average target across some or all series in a regression project. For example, various statistics can be extracted based on a total or average target value. The dataset can also be analyzed for the presence of hierarchical structures (e.g., product and category, department and store, store and region). Additional modeling strategies are provided for hierarchical datasets.

To produce accurate forecasts in a demand forecasting setting, data scientists can account for holidays and/or promotions. Demand forecasting and sales data are often full of extreme events where sales can spike or drop. Examples include a high volume of sales during Black Friday in the USA and/or a couple of days or weeks before Christmas, and a low volume of sales on Christmas day itself. Such events are difficult to predict accurately without special treatment for such periods.

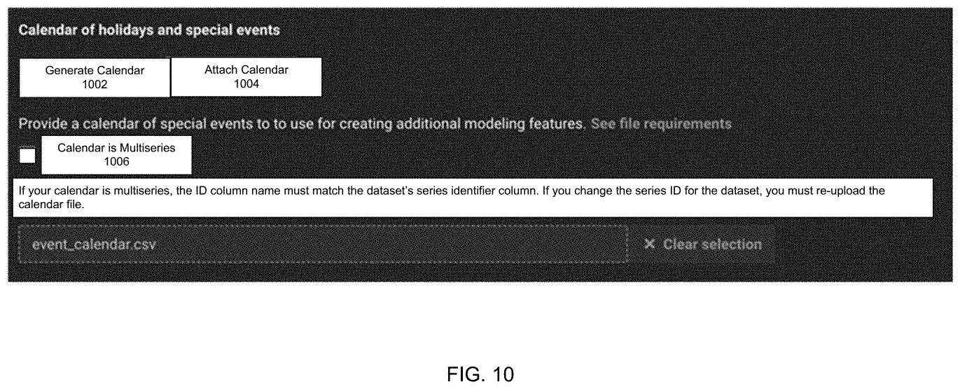

Advantageously, referring to FIG. 10, the systems and methods allow data scientists and analysts to set up a calendar of holidays and/or special events. A user can provide holiday information, for example, by inputting calendar information and/or providing a file with a holiday schedule. The information can be used to derive one or more features related to holidays or other special events, as described herein.

For example, the system 100 can provide, for presentation by a graphical user interface via a display device coupled to a computing device, a user interface element 1002 or 1004 to input a calendar of events to generate a feature for the plurality of time series. The user can generate a calendar 1002 or can attach a calendar 1004. The user can indicate whether the calendar is multiseries via user interface element 1006. The system 100 can receive, via the user interface element 1002 or 1004, the calendar of events. The system 100 can derive one or more features of the first dataset using the calendar of events.

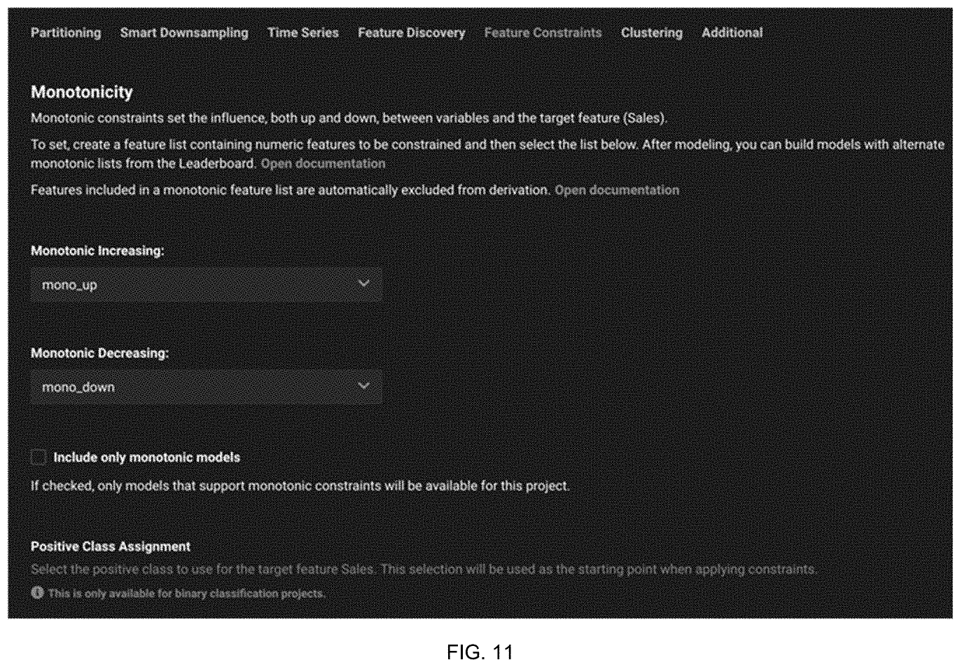

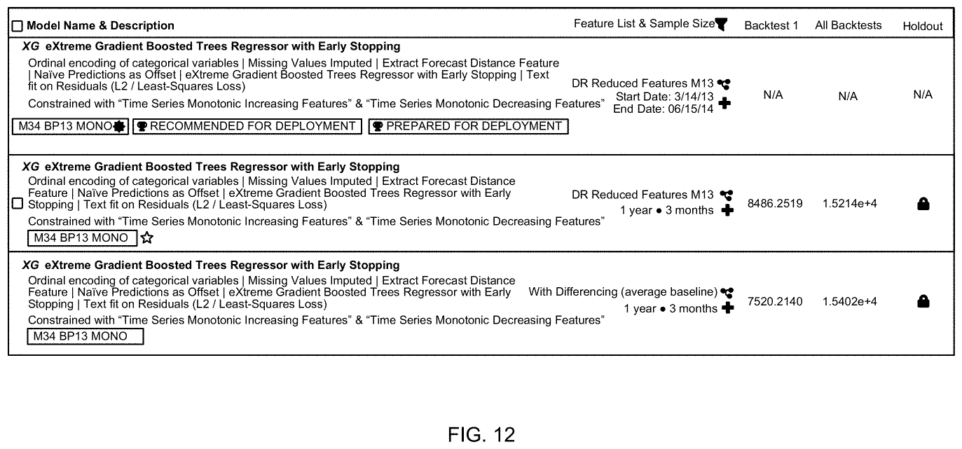

In various examples, the systems and methods allow users to configure monotonicity constraints for time series data. A monotonicity constraint can use a prediction to vary monotonically with respect to one or more features. For example, referring to FIG. 11, a graphical user interface can allow a user to create two lists of numerical features: one feature list that includes monotonically increasing features (e.g., predictions increase as the feature values increase), and another feature list that includes monotonically decreasing features (e.g., predictions decrease as the feature values increase). Features from these lists can be used in an Extreme Gradient Boosting Model (XGBoost) as monotone_constraints or as constraints in other models so that predictions can vary monotonically with respect to the features. Users can choose to use only models that include or permit such monotonic constraints. For example, FIG. 12 illustrates an example where the systems and methods build only eXtreme Gradient Boosting (XGB) models.

### Feature Engineering and Data Partitioning

In various examples, feature engineering and data partitioning can be performed in a similar manner for both segmented and non-segmented time series projects. Referring again to FIG. 1, when a time series project is started, the feature engineering module 106 can: perform feature engineering of time series specific features; reduce or eliminate features that are not important or less important than other features; and/or partition data into walk-backward backtests (e.g., as described above for FIG. 7).

### Feature Engineering

In various examples, the feature engineering process can extract time series features from a feature derivation window (FDW). The feature engineering module 106 can detect whether a dataset (i) has single or multiple seasonality (can be overridden by the user), (ii) exhibits an exponential trend, and/or (iii) is stationary or non-stationary. For example, seasonality can be detected using a generalized linear model (GLM) or similar model in a target, a timestamp, and/or extracted date features. To detect whether a dataset has intra-day seasonality, for example, the following steps can be performed: (i) extract day of week, hour of day, and minute of hour features from raw dates; (ii) fit a GLM model using extracted features (e.g., fit one GLM model for each series in the dataset); (iii) extract p-values of each date extracted feature and filter out insignificant features (e.g., using an alpha value of 0.001); and (iv) if a date feature has a low enough p-value (e.g., below a threshold value), the feature can be considered significant and seasonality can be considered present. For example, if a day of the week feature is significant, the feature engineering module 106 can conclude that the dataset contains intra-week seasonality. To determine whether the dataset has an exponential or multiplicative trend, the feature engineering module 106 can utilize Guerrero's method or other suitable method.

To detect if data in the dataset is stationary, the feature engineering module 106 can use, for example, a combination of two tests: a KPSS (Kwiatkowski-Phillips-Schmidt-Shin) test and an ADF (Augmented Dickey-Fuller) test. In the KPSS test, a null hypothesis is that the series is stationary. If a KPSS p-value is less than a threshold value (e.g., 0.05), then the null hypothesis is rejected (i.e., the data is not stationary); otherwise, the null hypothesis is not rejected. In the ADF test, a null hypothesis that the series is non-stationary. If an ADF p-value is less than a threshold value (e.g., 0.05), then the null hypothesis is rejected (i.e., the data is stationary); otherwise, the null hypothesis is not rejected. For example, the feature engineering module 106 can conclude that a series is stationary when the KPSS p-value is greater than or equal to 0.05 and the ADF p-value is less than 0.05.

Depending on the characteristics above, the feature engineering module 106 can derive a variety of features for original numeric features. For example, the feature engineering module 106 can derive a 1st, 2nd, 3rd, 4th, and 5th lag of a feature (e.g., where the 1st lag is a feature value at a previous time step, the 2nd lag is a feature value at a time step immediately preceding the previous time step, etc.). This can involve extracting the Nth most recent value in the feature derivation window. The minimum number of lag for any project may be 1. For projects with zero forecast distance, the last value in the feature derivation window can be a value at a forecast point, because of a project setting with FDW=[−n, 0] and FW=[0]. The 1st lag can be equivalent to an actual value known at the forecast point.

The feature engineering module 106 can also derive statistics in several rolling windows depending on FDW size (e.g., min, max, median, mean, and/or standard deviation) and/or latest and seasonal naive baseline features. Naive baseline features can be determined by selecting values from history to forecast future values, based on different strategies. For example, a naive latest prediction can use the latest history value to predict rows or values in the forecast window. Naive seasonal prediction can extract a previous season's target value in the history to predict values in the forecast window. For example, for a given Monday-Friday dataset, a naive latest prediction for a Monday can use a target value from a preceding Friday as the prediction for Monday. For a naive 7-day prediction, the feature engineering module 106 can use a target value from a previous Monday as the prediction for a next Monday. If a multiplicative or exponential trend is detected in the dataset or series, the naive prediction can be in log scale.

The feature engineering module 106 can also derive velocity and acceleration features from one or more original features. The velocity and acceleration features can be or include, for example, first and second derivatives, respectively, of the original features, with respect to time. In general, when a dataset has an exponential trend, some or all numeric features and/or their derivatives can be log-transformed.

The feature engineering module 106 can derive similar features for the target variable. For example, the following features can be derived for the target variable: 1st, 2nd, 3rd, 4th and 5th lag; statistics in several rolling windows depending on FDW size (e.g., min, max, median, mean, standard deviation); latest and seasonal naive baseline features; velocity and acceleration; and a possible log-transformation of the target variable and/or features derived from the target variable (e.g., derivatives).

Features can also be derived for categorical features. For example, the feature engineering module 106 can calculate various fractions or levels for categorical features, such as 10% of feature values are in category A, 15% of features values are in category B, etc.

Other features can be derived in addition to raw features and/or their derivatives. Differencing can be done in a variety of ways depending on whether the dataset has seasonality or not. For example, differencing can be done against a latest known value of the feature in the feature derivation window (FDW). For example, if a feature derivation window covers a previous seven days and a forecast point is on February 22nd, latest differencing can be performed by subtracting the target on February 21st from the target on February 22nd. Additionally or alternatively, seasonal differencing can be performed when the dataset is detected to have a seasonality. For example, if a daily dataset has (i) a weekly seasonality, (ii) a feature derivation window covering a previous seven days, and (iii) a forecast point of February 22nd, then seasonal weekly differencing can be performed for the target value on February 21st (e.g., a Sunday) by finding the target value from February 14th (e.g., a previous Sunday). The differenced target value for February 21st can be equal to a difference between the target value on February 21st and the target value on February 14th.

For features known in advance, the feature engineering module 106 can generate lagged features. Original values for the features known in advance can be retained. For features not known in advance, actual values can be dropped (e.g., not used or considered for feature engineering) as there may be no expectation for users to provide such features.

The feature engineering module 106 can generate calendar features using a calendar file provided by a user. The derived calendar features can include, for example, a next/previous event (e.g., a holiday), number of days to a next event, number of days from previous event, and/or various lags and statistics of the derived features in the feature derivation window, for both numerical and categorical features. The lag and statistical features can include or be similar to previously described lag and statistical features, such as 1st lag, 2nd lag (and/or other lags), minimum value, maximum value, mean value, standard deviation, and/or other statistical features.

Cross-series features can be calculated based on combinations of one or more features (e.g., if cross series features are enabled by the user). Cross-series features can be or include, for example, total sales (e.g., a 28-day combination of multiple sales time series), average sales (e.g., a 7-day average of multiple sales time series), etc.

Temporal aggregate features can be derived for temporal hierarchical models. Such features can aggregate target data to higher time unit. For example, if the target is daily sales, the feature engineering module 106 can create a weekly aggregate sales feature (e.g., a sum of sales in a single week) and/or a monthly aggregate sales feature (e.g., a sum of sales in a single month). Temporal hierarchical models can use temporal aggregate features as additional targets.

Additionally or alternatively, a dataset can be changed to support multiple forecast distances. For example, a simple monthly dataset may be as shown in Table 1.

TABLE 1
Monthly Dataset.

| Date | Target |
|---|---|
| May 1st | 472 |
| June 1st | 535 |
| July 1st | 622 |
| August 1st | 606 |
| September 1st | 508 |
| October 1st | 461 |
| November 1st | 390 |

To derive 3 forecast distances (e.g., predictions for 3 months ahead), one step ahead targets (FD=1) can be derived as shown in Table 2.

TABLE 2
Monthly dataset with one step ahead targets

| Date | Target | Target FD = 1 |
|---|---|---|
| May 1st | 472 | 535 |
| June 1st | 535 | 622 |
| July 1st | 622 | 606 |
| August 1st | 606 | 508 |
| September 1st | 508 | 461 |
| October 1st | 461 | 390 |
| November 1st | 390 | null |

Target FD=1 in this example is a lookahead value, where the value for a particular date is a value at the next month, e.g., target FD=1 for May 1st is a value observed on June 1st. FD=2 and FD=3 targets can be derived in a similar manner, as shown in Table 3.

TABLE 3
Monthly dataset with step ahead targets.

| Date | Target | Target FD = 1 | Target FD = 2 | Target FD = 3 |
|---|---|---|---|---|
| May 1st | 472 | 535 | 622 | 606 |
| June 1st | 535 | 622 | 606 | 508 |
| July 1st | 622 | 606 | 508 | 461 |
| August 1st | 606 | 508 | 461 | 390 |
| September 1st | 508 | 461 | 390 | null |
| October 1st | 461 | 390 | null | null |
| November 1st | 390 | null | null | null |

The data can then be transformed to have a single target (e.g., using a “melt” function or an inverse of a pivot function), as shown in Table 4.

TABLE 4
Monthly dataset with a single target.

| Date | Forecast Distance | Target |
|---|---|---|
| May 1st | 1 | 535 |
| June 1st | 1 | 622 |
| July 1st | 1 | 606 |
| August 1st | 1 | 508 |
| September 1st | 1 | 461 |
| October 1st | 1 | 390 |
| May 1st | 2 | 622 |
| June 1st | 2 | 606 |
| July 1st | 2 | 508 |
| August 1st | 2 | 461 |
| September 1st | 2 | 390 |
| May 1st | 3 | 606 |
| June 1st | 3 | 508 |
| July 1st | 3 | 461 |
| August 1st | 3 | 390 |

A single column called target can be derived that contains targets on a future date, as shown in Table 5. A new column called forecast distance can be included that specifies a horizon of the target. The date in the previous table (Table 4) can become a forecast point (e.g., a point from which forecasts can be made, not an actual date of the forecast). The date of the forecast can be derived, as shown.

TABLE 5
Monthly dataset with a forecast point, date of forecast, and a single target.

| Forecast Point | Date | Forecast Distance | Target |
|---|---|---|---|
| May 1st | June 1st | 1 | 535 |
| June 1st | July 1st | 1 | 622 |
| July 1st | August 1st | 1 | 606 |
| August 1st | September 1st | 1 | 508 |
| September 1st | October 1st | 1 | 461 |
| October 1st | November 1st | 1 | 390 |
| May 1st | July 1st | 2 | 622 |
| June 1st | August 1st | 2 | 606 |
| July 1st | September 1st | 2 | 508 |
| August 1st | October 1st | 2 | 461 |
| September 1st | November 1st | 2 | 390 |
| May 1st | August 1st | 3 | 606 |
| June 1st | September 1st | 3 | 508 |
| July 1st | October 1st | 3 | 461 |
| August 1st | November 1st | 3 | 390 |

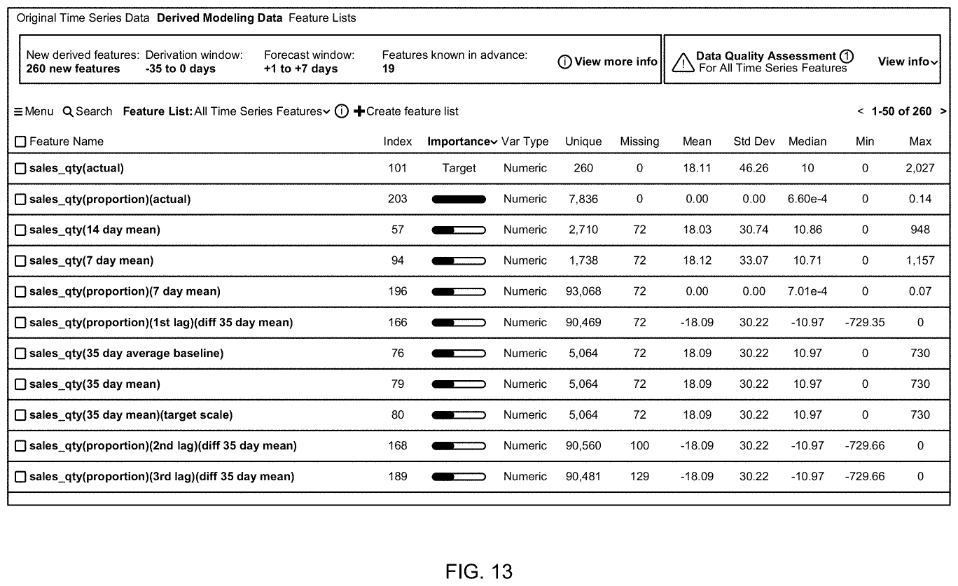

FIG. 13 includes a screenshot of an example graphical user interface providing a summary of derived features. In the depicted example, the number of features known in advance is 19 and the number of new, derived features is 260. The feature derivation process can significantly increase the number of available features, compared to the original dataset.

### Feature Reduction

Referring again to FIG. 2, once the feature derivation process has been performed, the feature engineering module 106 can begin a feature reduction process in which one or more features that are redundant or not impactful can be removed or ignored from further consideration. Feature reduction can be performed using proprietary algorithms based on GBT (Gradient Boosting-based Tree) and/or SHAP (SHapley Additive exPlanations) algorithms. Feature reduction can involve fitting a Light Gradient Boosting Machine model (LGBM) on all derived features (e.g., in a matrix having a size or shape of num_observations×num_features). A tree explainer (e.g., TreeExplainer from a SHAP library) can be fit using the LGBM model. Next, using the tree explainer, shapley values can be obtained for each observation from the data. The resulting shapley values can be provided in a matrix (e.g., having a size or shape of num_observations×num_features). Each value in the shapley values matrix can provide a measure of how much a feature contributes to a prediction. For example, the shapley value in element (i,j) of the matrix can be a contribution that feature j has on the prediction for observation (i). Next, a mean(abs(shapley values)) is calculated (e.g., in a direction along the rows) to obtain a single vector (of shape num_features) in which each value j is a mean contribution that feature j has on all the predictions. The vector can then be normalized to sum to 1 by dividing each value by a total sum of all elements in this vector, and the normalized vector can be sorted (e.g., from largest to smallest). Finally, features corresponding to large values in the normalized vector can be retained and all other features can be eliminated or removed from further consideration. For example, the top features (e.g., features with the highest contributions) that sum to a specified threshold (e.g., 0.98) can be retained and used as a reduced set of features.

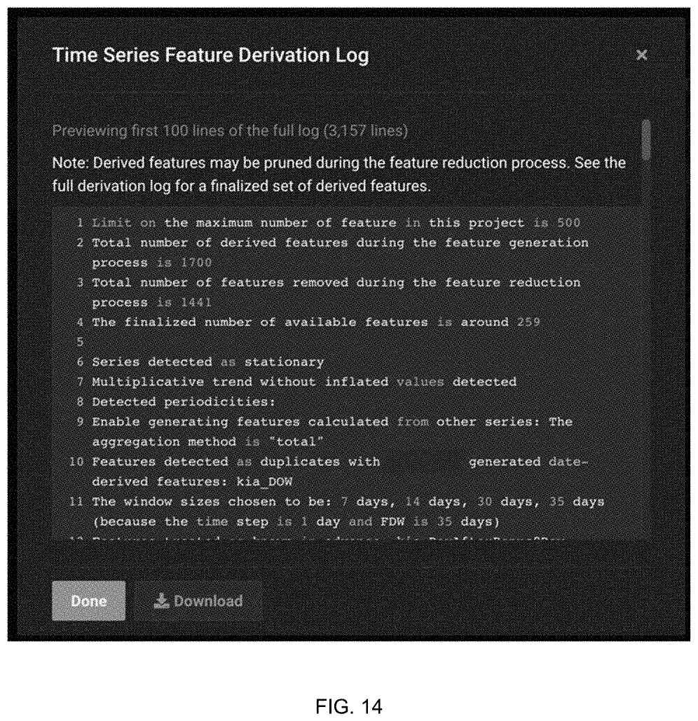

Referring to FIG. 14, a log file (e.g., a Time Series Feature Derivation log file) can be created that provides details on feature engineering and feature reduction steps. The log file can include information related to seasonality, trend, feature derivation window sizes (e.g., in which rolling statistics will be computed), the derived features, and the reduced features. Users can be provided with feature-specific insights, such as feature distribution histograms and/or frequent values.

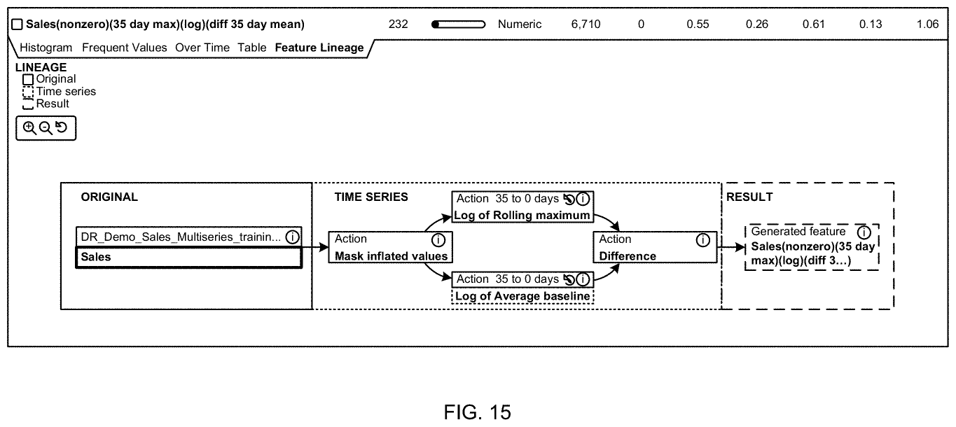

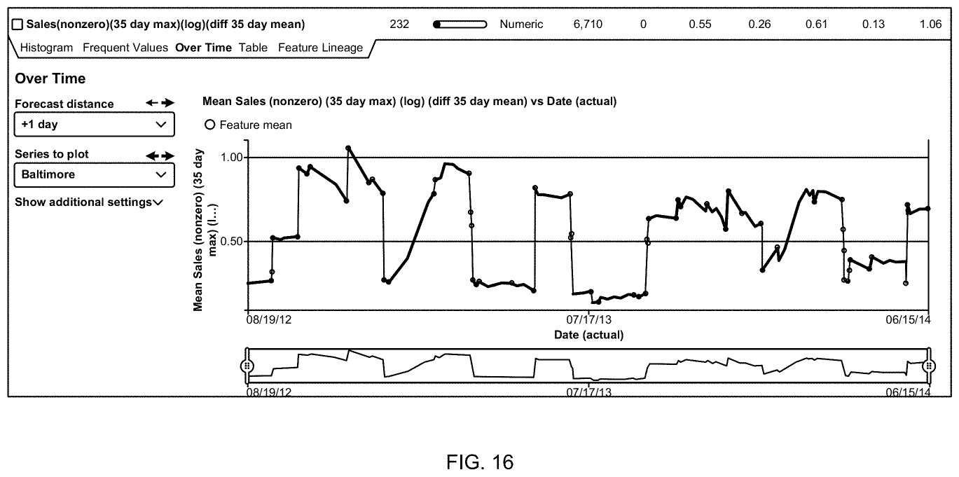

Referring to FIG. 15, a feature lineage graph can be generated that illustrates how a specific feature was created. For example, the feature lineage graph can indicate that a feature referred to as “Sales (nonzero) (35 day max) (log) (diff 35 day mean)” was created by: providing a sales column; masking out inflated values (e.g., zero values); calculating a rolling maximum (e.g., for a 35-day window) and log transforming the rolling maximum; providing a log-transformed average baseline feature (created separately); and calculating a difference between the log-transformed rolling maximum and the log-transformed average baseline feature. A feature over time plot can be created for each feature, as shown in FIG. 16.

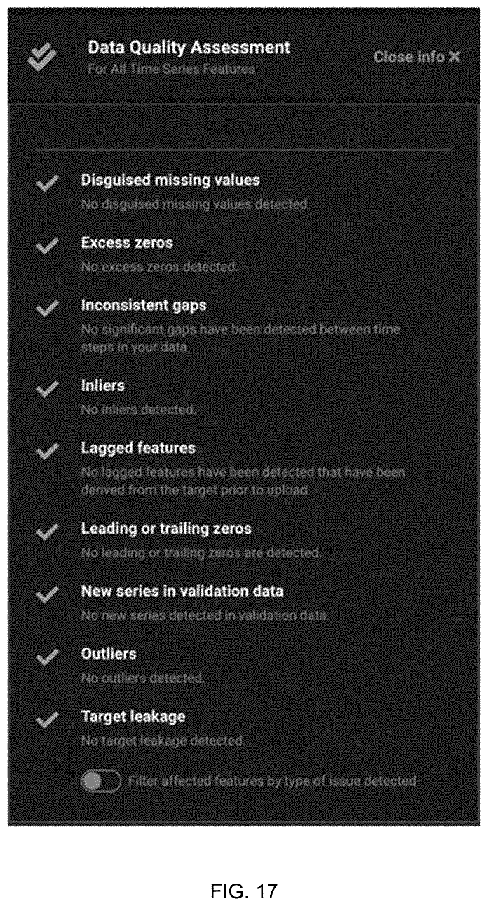

In various examples, the feature engineering module 106 can perform several data quality checks on datasets. The predictive power of resulting models can depend on a quality of the data/features used during training, thus the feature engineering module 106 can perform several time series specific data quality checks. For example, the feature engineering module 106 may look for any of the following data quality issues: inconsistent gaps between time steps in data (e.g., due to inconsistent measurement times or gaps in available data); lagged features that have already be derived by users (e.g., such features can be detected and flagged, marked as do-not-derive, or can be removed from the dataset); leading or trailing zeros (e.g., at a beginning or end of a column); a new series in validation data (e.g., a time series in validation data that was not present in training data). Results from the data quality checks can be displayed for the user, as shown in FIG. 17.

### Model Development and Assessment

Referring again to FIG. 1, the model development module 108 can receive (from the feature engineering module 106) a dataset having a plurality of features and can pick a set of best models to train based on the characteristics of the dataset. Such characteristics can include, for example, seasonality, trends, type of target (e.g., regression vs classification), size of the FDW, size of the forecast window (FW) (e.g., wide FW mode vs 0 FW mode), target distribution, or any combination thereof. For example if the dataset target is Gamma distributed, the system 100 may train different variants of LSTM-based (Long Short-Term Memory-based) models, thereby optimizing Gamma negative log-likelihood and/or Gamma deviance. The model development module 108 can select models from an available set of candidate models, as described herein.

In various implementations, the model development module 108 can propose and/or create models based on different lists of features available for the data set (e.g., original features and/or features derived during the feature engineering process described above). Such feature lists can include, for example: baseline feature lists (e.g., having latest and seasonal baselines; such lists may include only date, target, and naive prediction features, such as values from previous time step); “no differencing” feature lists and/or no differencing feature lists for Hierarchical models (e.g., a feature list that includes all features that have not been transformed using differencing, such as minimum sales over a 7-day span, mean sales over a 14-day span, or maximum sales over a 35-day span); “with differencing” feature lists, such as latest, seasonal, average baseline, and average baseline for Hierarchical models (e.g., a feature list identifying features that have been transformed using a differencing strategy, such as a value at a current time step minus a value at a previous time step, or a value at a current time step minus a value at a previous seasonal time step, such as a difference in sales between two days that are seven days apart); target derived feature lists (e.g., a list of features derived only from the target); date feature lists (e.g., a list that includes only date and target, which can be useful for univariate models like autoregressive integrated moving average (ARTMA)); lists of time series informative features (e.g., a list of all generated features, regardless of differencing, which can be a combination of some or all other feature lists). In general, each feature list includes a listing of features that (i) are available for the model (e.g., original features and derived features) and (ii) satisfy the respective feature list criteria for inclusion in the list. The different feature lists and the corresponding features included in each list are summarized in Table 6.

TABLE 6
Feature list summary and recommended models.

| | Features to Include | Recommended |
|---|---|---|
| Feature List | in the Feature List | Models |
| Baseline feature list | Date, target, and latest naive | ARIMA, VARMAX, |
| with latest baselines | prediction features | LSTM, and DeepAR |
| Baseline feature list | Date, target, and latest naive | ARIMA, VARMAX, |
| with seasonal baselines | prediction features | LSTM, and DeepAR |
| No differencing feature | Features that have not been | XGBoost, LGBM, |
| list | transformed through differencing | Linear, DeepAR |
| With differencing | Features that have been transformed | XGBoost, LGBM, |
| feature list | using a differencing strategy | Elastic Net, linear |
| Target derived feature | Features derived only from the target | XGBoost, LGBM, |
| list | | Elastic Net, linear |
| Date feature list | Only date and target | ARIMA |
| Informative features | All generated features, regardless of | Various |
| (e.g., all features) | differencing | |

Each model picked by the model development module 108 can be trained on features from a feature list that is considered to be suitable or optimal for the model. Other features that may be available but are not present in the feature list can be ignored during training of the model. Table 6 identifies the models that are recommended for each feature list. In some examples, the baseline feature list with latest baselines can be optimal or suitable for DeepAR models (e.g., supervised learning algorithms that use recurrent neural networks (RNN) to forecast scalar (one-dimensional) time series). The baseline feature list with seasonal baselines can be optimal or suitable for ARIMA models. The no differencing feature list can be optimal or suitable for DeepAR, while the with differencing feature list can be optimal or suitable for XGB (Extreme Gradient Boosting) and Elastic Net models. Temporal Hierarchical features can be optimal or suitable for XGB. The recommended models listed in Table 6 have been selected and verified based on experiments performed on a large number and variety of time series datasets.

Referring again to FIG. 1, in various examples, the model development module 108 can use a multi-stage autopilot (also referred to as simply “autopilot”) to automatically select or pick one or more models (e.g., a best model) from a variety of available models. According to a “no free lunch theorem,” there is generally no best model that is going to be accurate or successful for every possible dataset. Some datasets may be dominated by linear models and others may be dominated by trees or neural nets; however, training every possible model is time consuming and usually not possible. Multi-stage autopilot can be used to efficiently try a large number models and pick the best one.

Additionally or alternatively, multi-stage autopilot can address problems associated with losing time series signals that go further back in time than other signals. While training on data that goes further back in time can help predict the future more accurately in some instances, such training can hurt model accuracy in other instances. Multi-stage autopilot can allow models to be trained on different sample sizes (e.g., different time ranges) and can compare such models with one another.

In some instances, for example, the multi-stage autopilot can train models on a small amount of data (e.g., small sample size) and subsequently train models on larger amounts of data, while evaluating model performance and retaining only the best models. This can be referred to as a multi-armed bandit approach. To perform the multi-armed bandit technique, the multi-stage autopilot can begin by picking a large number of models that are suitable for a dataset (e.g., usually more than 20 types of models). The models can include, for example: regression models (e.g., linear regression models) for use with regression datasets, targets, or problems; tree-based models; neural networks; zero-inflated models (e.g., zero-inflated XGBoost and/or LGBM models) for datasets that are zero-inflated; and/or hierarchical models (e.g., for projects configured to have cross-series features).

The selected models can then be trained (e.g., using features from a feature list corresponding to each model) and evaluated on different sample sizes. For example, in a first stage, the selected models can be trained on a small sample size (e.g., 25% of the samples from a single backtest, which is a portion of the entire dataset) that allows a large number of models to be trained quickly, to determine which models perform the best and/or weed out models that perform poorly. Next, in a second stage, a subset of best-performing models (e.g., 16 total) from the original set of models can be selected and trained on a larger sample size (e.g., 50% of the samples from the single backtest). A subset of best-performing models (e.g., 4 or 8 total) can then be selected and trained on an even larger sample size (e.g., 100% of the samples from the single backtest). One or more best-performing models from the latest subset can then be selected as a best model for one or more time series in the dataset. Advantageously, the multi-stage approach can allow a large number of models to be trained and tested on smaller datasets, such that poorly performing models can be removed from consideration in an efficient manner. Only better performing models are advanced to a next round where the models are trained and evaluated on larger datasets, which can be more time-consuming or computationally expensive.

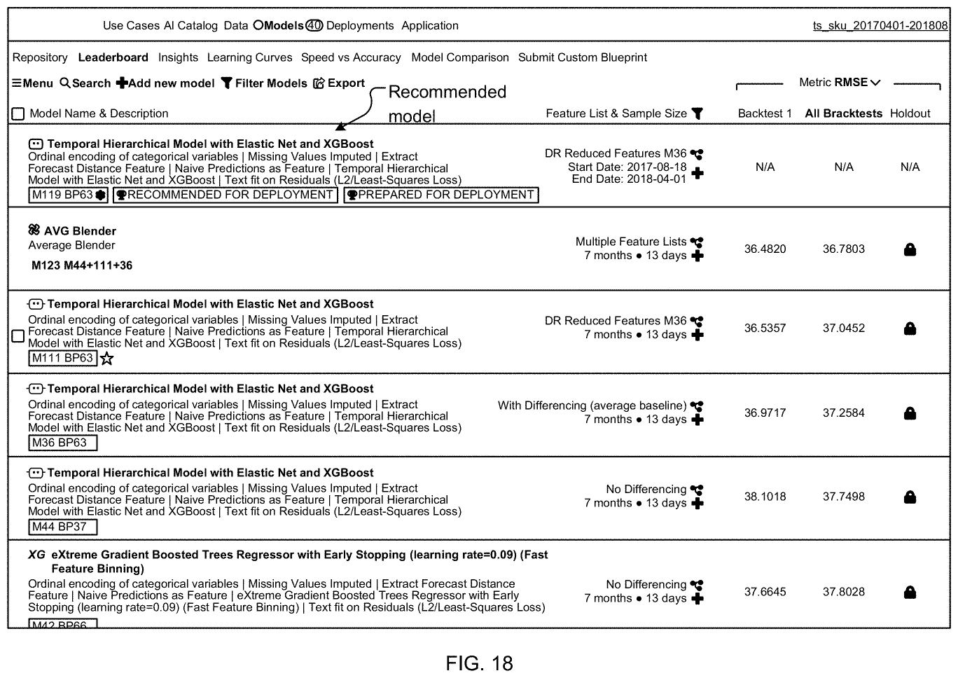

FIG. 18 is a screenshot of an example graphical user interface that presents a listing or leaderboard of the best models identified using the autopilot. The leaderboard identifies models that have been trained on respective feature lists that the model development module 108 considers to be the best for the uploaded dataset.

In certain examples, after the best models have been identified and trained for a dataset, the model development module 108 can create an average blender of a small subset (e.g., 3 total) of the best models and/or can select a best model that will be recommended for deployment. The recommended model is preferably one of the best models from the leaderboard. In FIG. 18, for example, the recommended model is a temporal hierarchical model on a reduced features list. The temporal hierarchical model can utilize a temporal hierarchical modeler with an Elastic Net modeler for a first stage and XGBoost for a second stage. The model can implement a two-level temporal hierarchical model, as follows: the first stage fits the average target aggregated to a coarse time scale one level above the time step for the dataset; and the second stage fits an allocation of the average aggregated target to each time step. The net prediction in this example can be a predicted aggregated average multiplied by the predicted allocation. The best model in the figure in terms of prediction accuracy is the second model in the leaderboard (e.g., an AVG Blender model); however, this is not the recommended model because it is not as fast (e.g., longer prediction times). In some examples, the model development module 108 can recommend models that are fast, in addition to being accurate. Blender models (e.g., models trained using features from multiple feature lists) are generally slower and, as a result, may not be the best model. Once a model has been recommended, the recommended model can be retrained on a full set of training data (e.g., for all features in the feature list for the model). The retrained model may then be ready for deployment. At this point, the user can deploy the model or may choose a different model (e.g., based on a manual model selection process).

In various implementations, when evaluating and selecting candidate models, the model development module 108 can determine and use an appropriate optimization metric, which can provide a measure of model error (e.g., an average difference between the target and a predicted value). The model development module 108 can choose an appropriate optimization metric based on a distribution of the dataset (or other dataset characteristics), and the chosen metric can be used to evaluate model performance (e.g., when choosing models for the leaderboard). For example, the metric can be chosen based on the type of target (e.g., RMSE or MAE can be selected for regression targets, and LogLoss can be selected for classification targets). Additionally or alternatively, the metric can be chosen based on an empirical distribution of the target. For example, RMSE can be used for a normal distribution, Poisson deviance can be used for a Poisson distribution, or Gamma deviance can be used for a Gamma distribution. The optimization metric can be specified or changed by the user (e.g., when a modeling project is created). The selected metric can be used to evaluate candidate models and recommend a best model for deployment, as described herein.

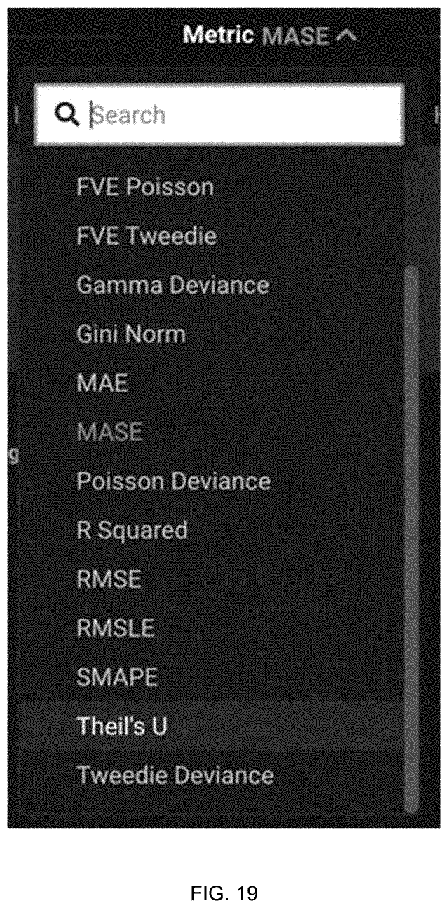

Referring to FIG. 19, in some examples, one or more metrics specific to time series can be available, such as Mean Absolute Scaled Error (MASE) and Theil's U error (FIG. 19). To obtain a better understanding of these two metrics, it can be helpful to first understand what the baseline model (or baseline prediction) means for time series problems. Baseline models are important in data science and machine learning in general. With no baseline available for comparison, it can be difficult to determine how much error is acceptable. Baseline models are often relatively simple models. For regression models, for example, a regression baseline can be an average value of a target in the training data (e.g., an average of a time series during a previous time period). For classification models, the baseline can be a majority class in the training data (e.g., “Yes” or “No,” depending on which one is a more frequent target value in the training data). The same baselines can also be used for time series; however, a more reasonable baseline is usually a model that provides a previously known value. For example, a prediction for tomorrow can be a known value from yesterday.

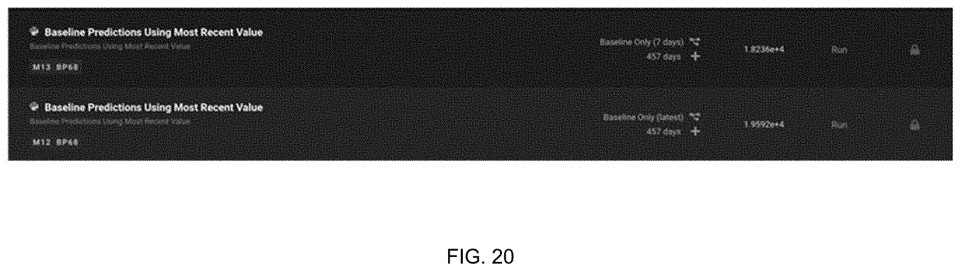

The model development module 108 can provide a variety of simple baseline models. For example, the baseline model can use a latest naive value, such as outputting yesterday's values as a prediction for tomorrow, a day after, etc. (for daily data), or outputting values from the previous month as a prediction for next month (for monthly data). Additionally or alternatively, the baseline model can use a latest seasonal naive value, such as outputting a value from last Monday as a prediction for next Monday (for a model with 7 day seasonality), or outputting a value from the first day of last month as a prediction for the first day of next month (for intra-month seasonality). Example baseline models are presented in FIG. 20.

MASE and Theil's U (and other metrics specific to time series) can use a baseline prediction to be provided, because the metrics can scale the value of a base metric (e.g., MAE or RMSE) with respect to a baseline model metric. For example, MASE can be given by MASE=MAE of the model/MAE of the baseline. Theil's U can be given by Theil's U=RMSE of the model/RMSE of the baseline.

By default, a longest period baseline can be used to compute such metrics. The longest period baseline can be, for example, a baseline that uses a longest periodicity (or seasonality). For example, consider hourly data related to rides in a taxi (e.g., a number of taxi rides per hour). The number of rides is likely to spike in the morning (when people commute to work) and again in the evening (when people commute from work), and the number of rides per day can be higher on business days and lower on weekends. Such a time series can have both intra-week and intra-day seasonality. Three baselines (naive prediction values) can be used for this dataset, as follows: latest baseline (e.g., a value from the previous hour, such as a value for 1:00 PM used as a latest baseline for 12:00 PM); a 24-hour baseline (e.g., a value from the same hour on a previous day, such as a value for 1:00 PM on Monday used as a baseline for 1:00 PM on Tuesday); and a 7-day baseline (e.g., a value from the same hour on the same day of the previous week, such as a value from 1:00 PM on a previous Monday used as a baseline for 1:00 PM on a next Monday). For example, FIG. 20 indicates that a baseline of a 7-day feature list will be used for one of the depicted baseline predictions.

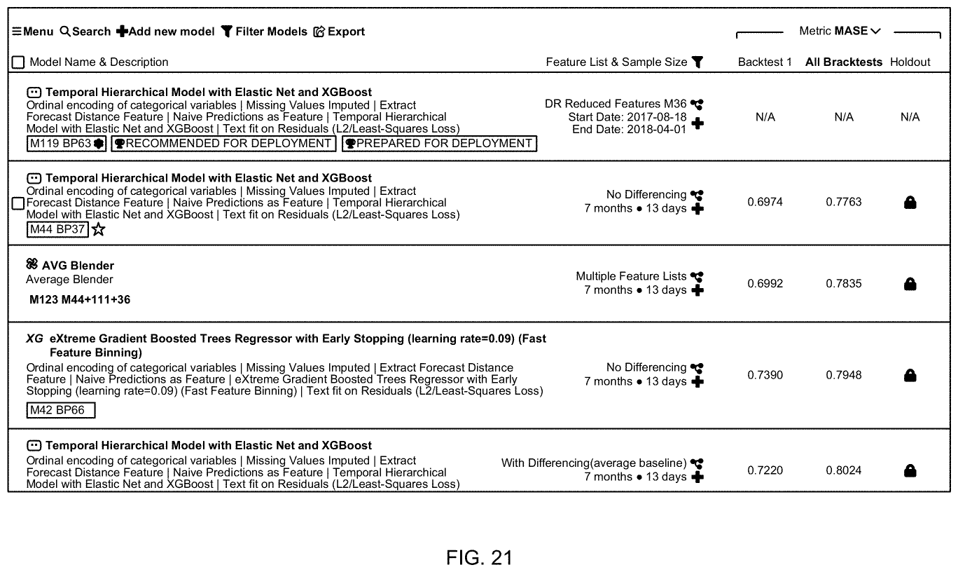

FIG. 21 is a screenshot of the leaderboard sorted by the MASE metric. Compared to the previous leaderboard in which the RMSE metric was used (in FIG. 18), the best models in the leaderboard have changed. This indicates that different models are performing better on the problem with respect to the baseline models.

### Model Management and Assessment

Referring again to FIG. 1, the model management module 110 can be used to monitor and assess model performance and output a variety of plots, charts, and tables that assist users with model interpretation. For example, the model management module 110 can provide a variety of information and insights related to model performance, such as, for example: plots or charts related to accuracy over time, forecasting vs. actuals, series accuracy and insights, model stability, and/or forecasting accuracy.

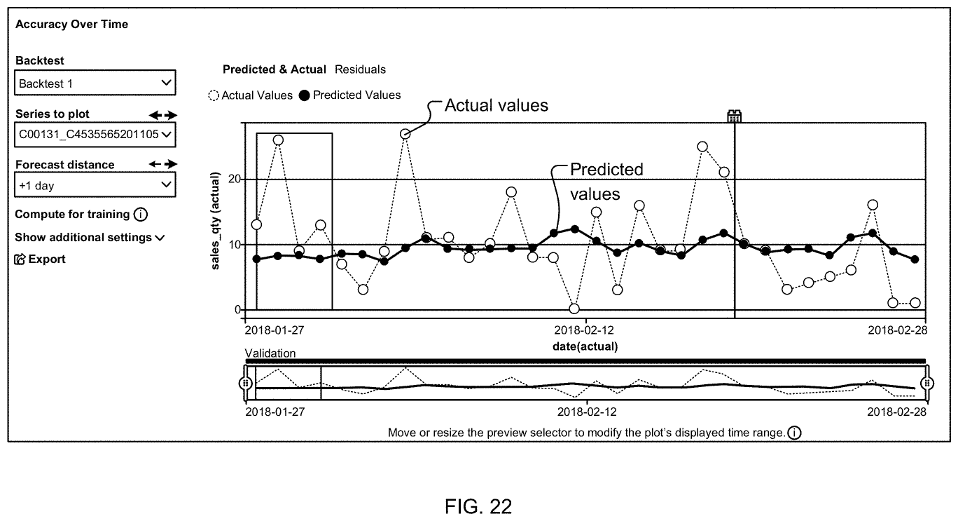

FIG. 22 includes a plot of model accuracy over time. The plot can allow a user to validate how well a model fits actual values in validation sets over time. Accuracy over time can be computed per series and per forecast distance and can provide an ability to validate individual time series (e.g., for products and/or product categories) and individual prediction horizons. FIG. 22 shows the accuracy over time plot for the model recommended in FIG. 18 (using the RMSE metric). In general, the model predicts values that are close to a mean target value but misses many of the peak values, which may not be ideal for the use case.

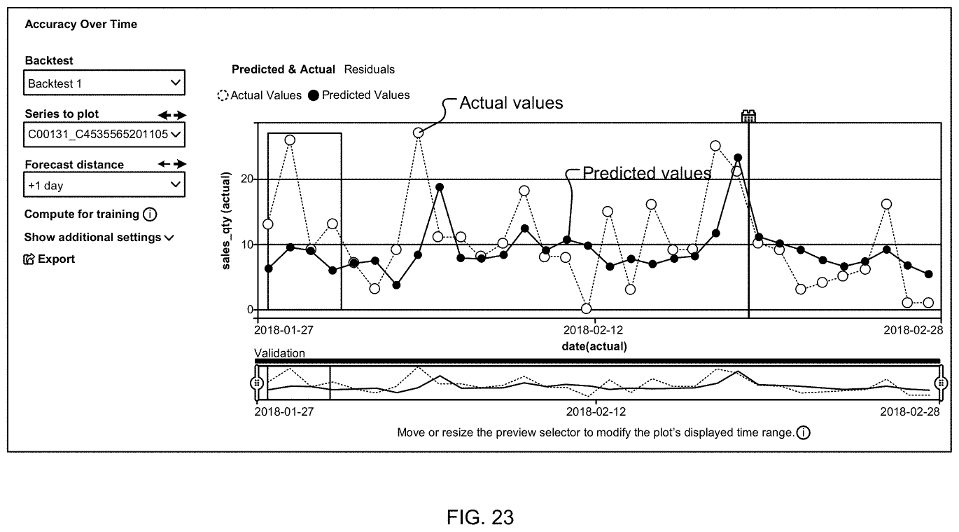

By comparison, FIG. 23 includes an accuracy over time plot for the model recommended in FIG. 21 (using the MASE metric), which is a Temporal Hierarchical Model trained on the no differencing feature list. The model generally does a good job of capturing more of the variation present in the actual values and therefore may be worthy of consideration as an alternative model for deployment.

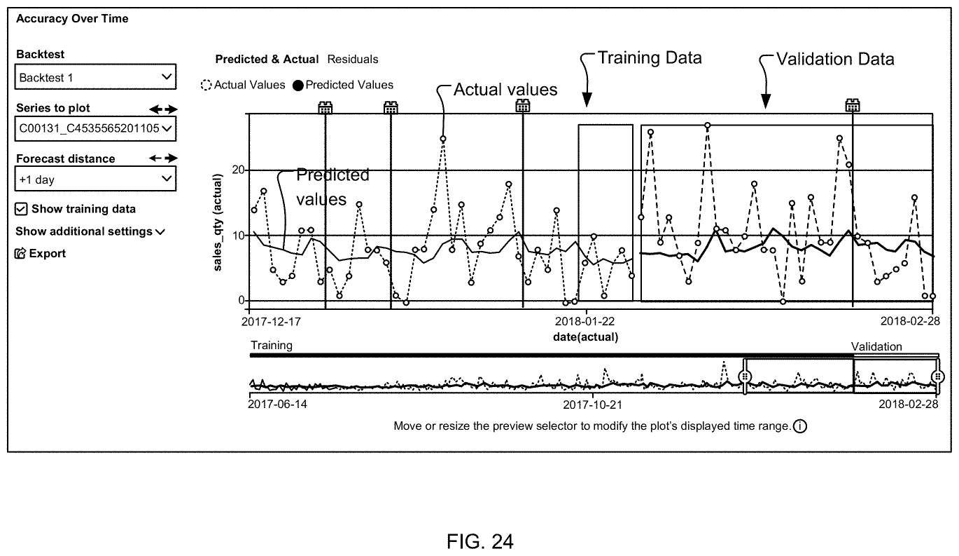

Accuracy over time (AOT) plots can also be used to view predictions vs. actuals for different backtests and/or series types (e.g., SKUs, categories, departments, etc.), explore different prediction horizons (e.g., forecast window lengths), and/or assess whether the model is overfitting or underfitting. For example, FIG. 24 is an accuracy over time plot on training data for one of the XGB models lower on the leaderboard. The results in the figure indicate that the model is underfitting the data.

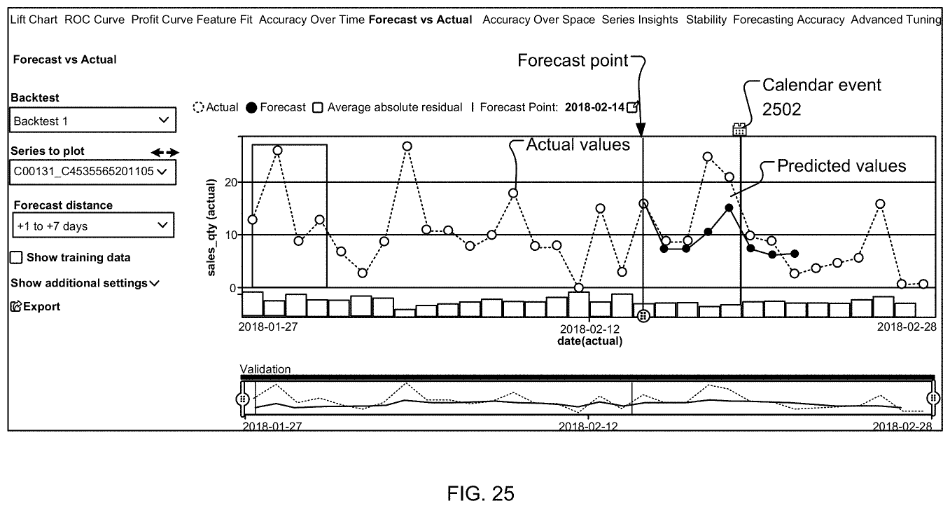

Another tool that the model management module 110 can provide for assessing model performance is a Forecast vs. Actual (FvA) plot. While the AOT plot can show accuracy of the model over time (e.g., per forecast distance separately), the FvA plot can show how well the model predicts all forecast distances, in a horizon starting from a specific forecast point. FIG. 25 includes an example FvA plot for the Temporal Hierarchical model (from FIG. 23). The FvA plot provides a similar assessment of the model as AOT, but with particular emphasis on how well the model extrapolates into the future.

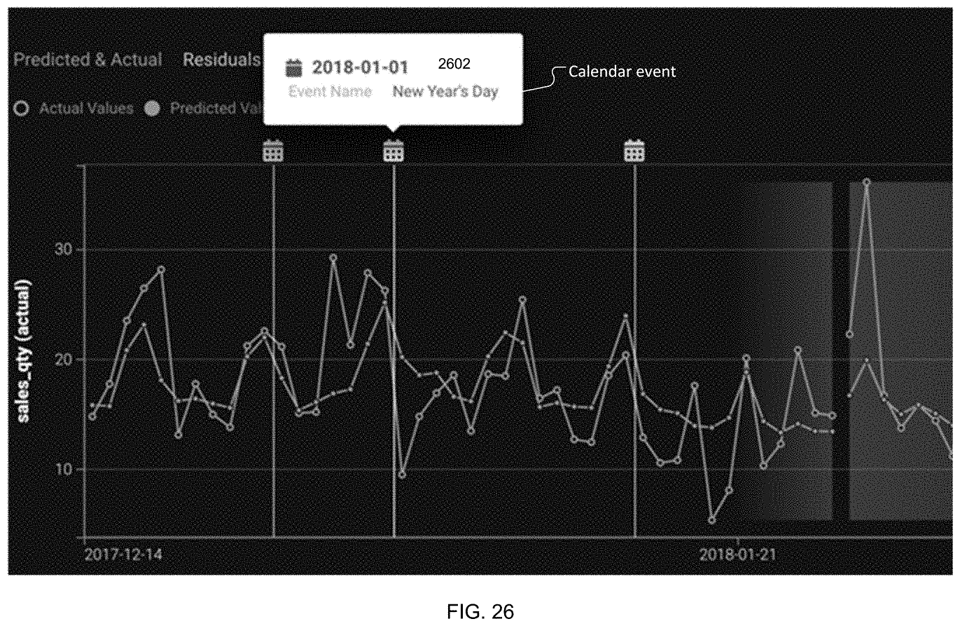

AOT and FvA plots can also display calendar events. For example, FIG. 25 shows a calendar event 2502 as a vertical line. Hovering a mouse pointer over the calendar event 2502 can cause information 2602 about the calendar event to be presented, as shown in FIG. 26. The feature can allow the user to verify how well calendar events have been captured.

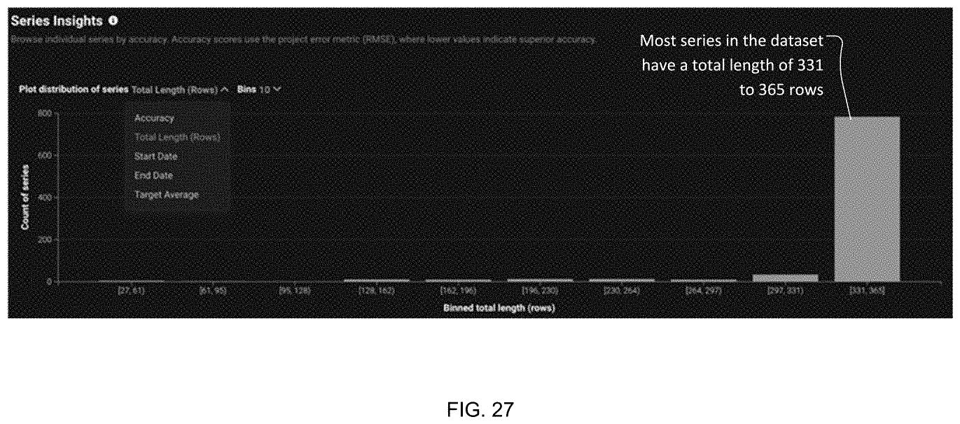

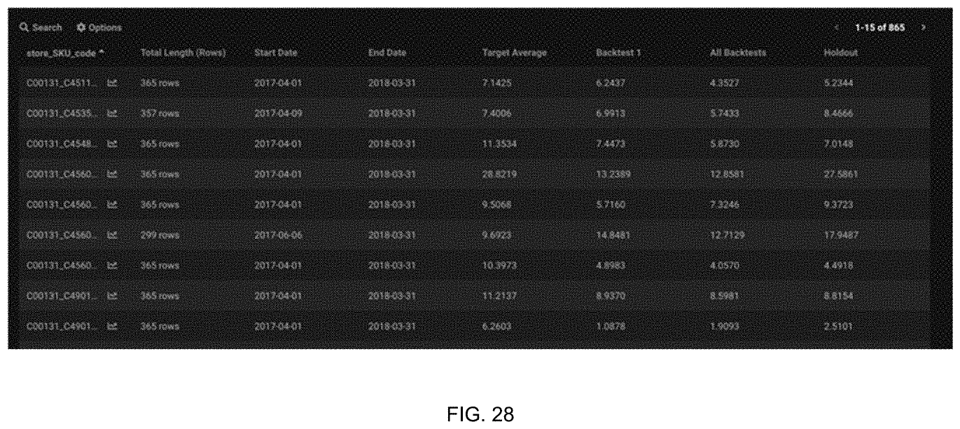

The model management module 110 can also provide series insights, which can be used to explore a dataset and model accuracy for individual series (e.g., SKU or product category). Series insights can become even more valuable for demand forecasting use cases because such use cases usually contain a large number of series. In some examples, series insights can allow distributions of series to be explored based on various characteristics of bins such as, for example, length, start/end dates, average target values, or accuracy of the series. FIG. 27 includes a histogram for total length. Each bar in the histogram represents a group of series having a number of observations that falls within a specified range. For example, a tallest bar in the histogram is for a bin corresponding to a total length from 331 to 365 rows. The bin contains about 800 series, which means 800 series in the dataset have from 331 to 365 rows. Other bins in the histogram have fewer series. For example, the second tallest bar is for a bin corresponding to total length from 297 to 331 rows, and this bin contains less than 30 series. Referring to FIG. 28, at a bottom portion of a series insights page, users can see accuracy per individual series per backtest. This can allow users to understand which series the model struggles to capture. Users can drill down to see accuracy over time and explore more.

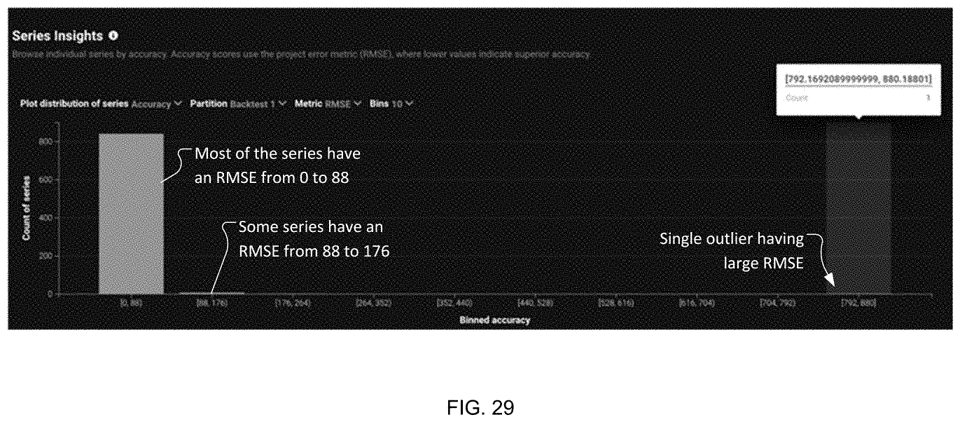

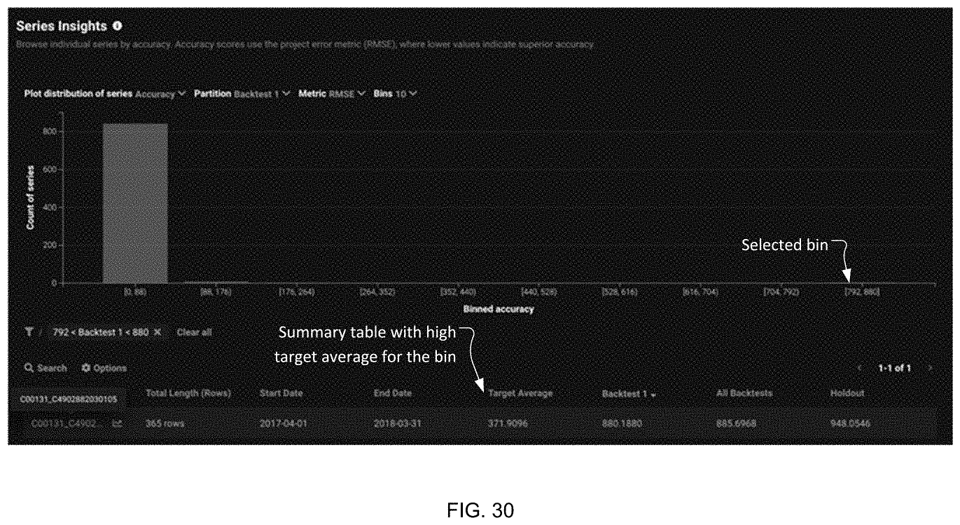

Additionally or alternatively, one way to determine which series a model struggles to predict accurately is to analyze an accuracy distribution. FIG. 29 includes an example accuracy distribution in which most of the series have RMSE in a range from 0 to 88, and some are in a range from 88 to 176. The figure also reveals an outlier series having RMSE in a range from 792 to 880. Clicking on the bin containing the outlier series can provide a summary table for the series, as shown in FIG. 30. Results in the table indicate that the series has an average target value of about 372, which is substantially higher than the average target values shown for other series in FIG. 28 (e.g., all less than 30).

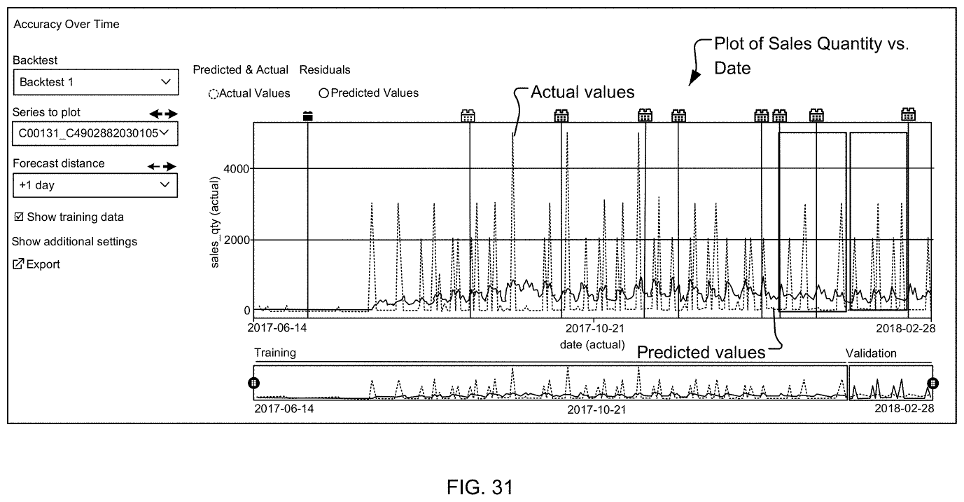

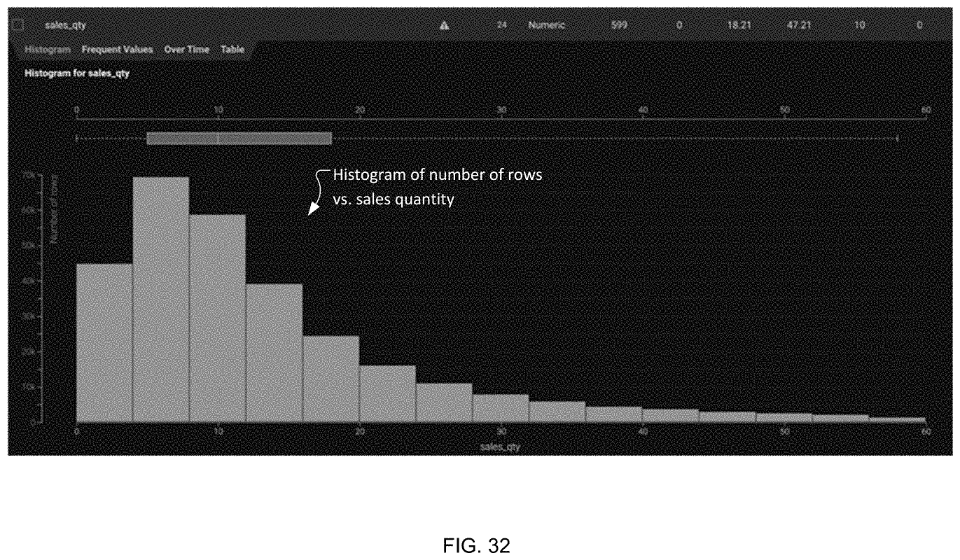

This capability can allow a user to drill down into a series, for example, by looking at an accuracy over time plot. For example, FIG. 31 is an accuracy over time plot for the series having the worst overall accuracy (e.g., the outlier series from FIG. 29). The figure reveals that the series has higher overall magnitudes of the target values (e.g., some greater than 4,000) and many zero values. The characteristics (e.g., large peak-to-peak variation with many zeros) of the series are considerably different from the characteristics of other series presented in FIGS. 22-24, where target values were in a range from 0 to 30 and there were only a small number of zero values. The plot in FIG. 31 indicates that the series likely follows a zero-inflated distribution with high overall magnitude of values. Further, FIG. 32 includes a histogram indicating that the series is Poisson distributed. The target is strictly greater than or equal to 0 and has a shape that looks similar to a Poisson distribution.

The results in FIGS. 29-32 indicate that the outlier series has unique characteristics and should be modeled separately from other time series using a model that is capable of capturing the characteristics of the outlier series. Other series having different characteristics (e.g., not zero-inflated and/or a lower overall magnitude of values) can be modeled with one or more different models. In this way, a segmented modeling approach can be utilized in which different models are used to simulate time series having different characteristics. The models can be combined into a combined model that can be used to simulate the entire collection of time series. For example, a user of the systems and methods can upload a dataset and the systems and methods can automatically identify and develop a plurality of models that are suitable for the time series present in the dataset. When making predictions on a set of prediction data, time series in the prediction data can be routed or mapped to appropriate models used in the combined model.

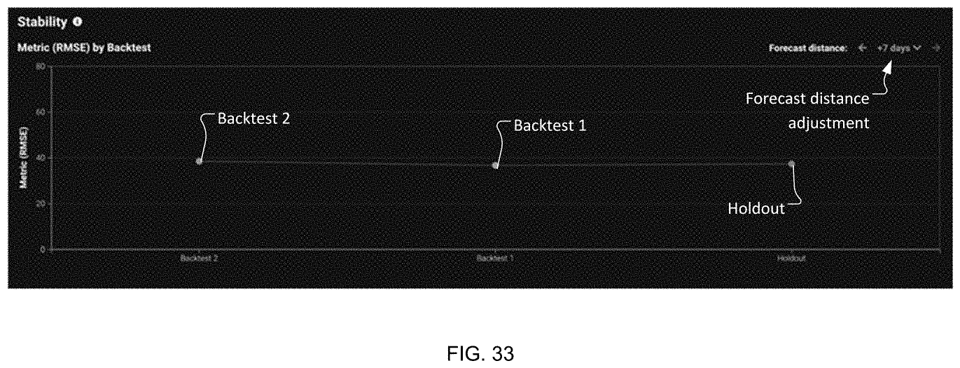

The model management module 110 can provide additional insights related to stability and forecasting accuracy. Stability information can allow a user to assess overall model stability across backtests, for example, to make sure models give more or less the same errors for different cross-validation folds. FIG. 33 is a plot showing prediction error (RMSE) for a model across different time periods. The figure shows that the prediction error is nearly constant across the different time periods and is therefore generally stable. This indicates that drastic drops in accuracy are unlikely to occur as the model makes predictions going further into the future. A user can adjust a forecast distance to verify stability for specific forecast distances.

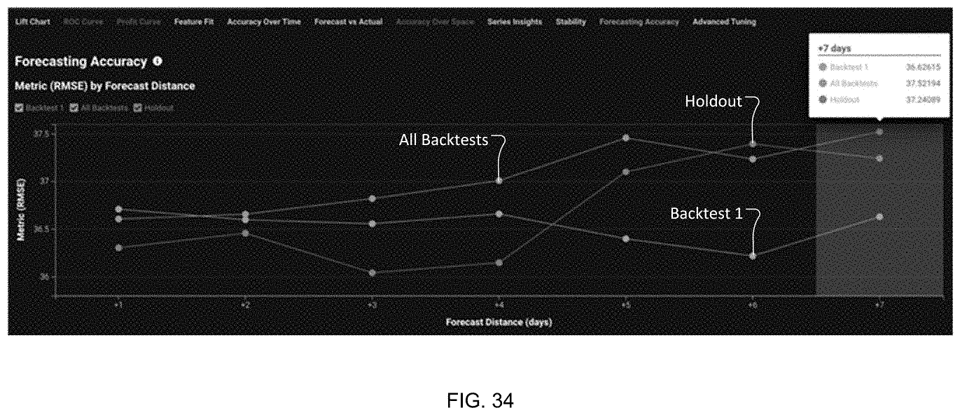

Additionally or alternatively, a plot of forecasting accuracy can allow a user to verify model performance stability across backtests, for various forecast distances. For example, the forecasting accuracy plot in FIG. 34 indicates that the model is generally stable with RMSE error varying between 36-37.5 units. The plot also indicates that overall model performance decreases when the model is used to make predictions further into the future (e.g., longer forecast distances). For example, RMSE for shorter forecast distances (e.g., 1 to 2 days) is generally smaller than RMSE for longer forecast distances (e.g., 5 to 7 days).

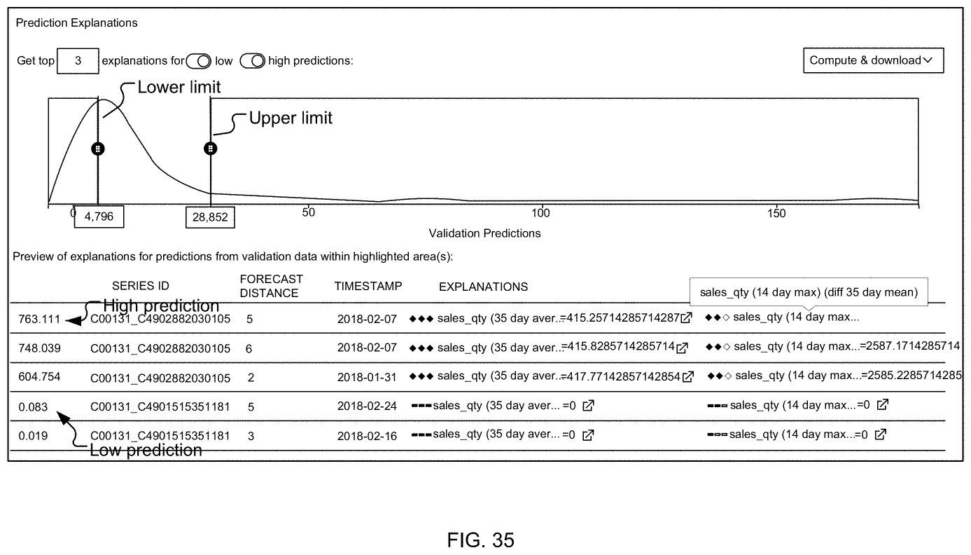

Additionally or alternatively, the model management module 110 can provide prediction explanations that can help users evaluate models and better understand model predictions. For time series and segmented time series projects, the model management module 110 can use an algorithm referred to as XEMP on time series derived features. FIG. 35 is a screenshot of an example graphical user interface presenting prediction explanation on a target distribution. A user can specify lower and/or upper limits and a desired number of prediction explanations corresponding to the lower and upper limits. For example, the user can request top three explanations for predictions that fall below the lower limit and/or top three explanations for predictions that are above the upper limit. In the depicted example, the upper limit is about 29 units and prediction explanations are provided for predictions of about 763 and about 748. The prediction explanations indicate that the features that contributed these predictions are sales_qty (35 days average baseline) having a value of about 415 and sales_qty (14 days max) (diff 35 day mean) having a value of about 2588. The prediction explanations indicate that having high values in a 35-day window can lead to high average of the sales_qty (35 days average baseline) feature, and having extremely high values in the window of 14 days can lead to an extremely high difference between 14 days max and 35 days mean. Both of these features resulted in the high prediction values in this example. On the contrary, when these features are 0, predictions are very close to 0, as indicated by the prediction explanations for low predictions of 0.083 and 0.019.

In various examples, the systems and methods described herein can provide and utilize a large set of models for training on a specific dataset. Models can be added or considered based on a large set of characteristics inferred during exploratory data analysis and feature engineering. The systems and methods can build both regular non-time series regression and classification models as well as time series specialized models.

Non-time series models may be possible to train because of the innovative feature engineering and feature reduction capabilities of the feature engineering module 106. Derived time series features such as lags and rolling stats can allow predictions for multiple time steps in a forecast window, which can effectively make the dataset non-time series. Such models can be based on, for example: extreme gradient boosted trees algorithm (XGBoost), light gradient boosted trees (Light GBM), deep learning models based on neural networks or MLP (multilayer perceptron) architecture, random forest, elastic nets, and/or Ridge regression.

Additionally or alternatively, time series specialized models are generally aware of the problem being time dependent. Algorithms for these models are usually optimized for time series problems and can include, for example: various algorithms based on ARIMA, VAR (Vector Auto-Regression), VARMAX (Vector Auto-Regression Moving-Average with Exogenous Regressors), Keras DeepAR, Seq2Seq (sequence-to-sequence), and/or other RNN based algorithms.

In some examples, the systems and methods support a set of hybrid models that are specialized for time series datasets but utilize non-time series algorithms and derived features. Such hybrid models can include, for example: performance clustered models based on XGBoost and Elastic net, temporal hierarchical models, similarity clustered models based on XGBoost, hierarchical models based on XGBoost and Ridge regression, and/or two stage proportional regressors based on XGBoost and Ridge regression.

The systems and methods can also develop and utilize time series specific blenders. Such blender models can include, for example: AVG/Median blenders, average forecast distance blenders, and/or ENET (elastic net) forecast distance blenders.

While many of the models described herein can be trained on whole data (e.g., a single model used for all series in a dataset), in certain instances the time series in a dataset can differ substantially and may be too different to be modeled together (e.g., using a single model). For example, the series in a dataset can have different seasonality and/or magnitudes that can be difficult to capture accurately with a single model. For datasets that include time series related to product sales, for example, some series in the dataset can describe sales for products that are sold weekly, while other series in the dataset can describe sales for products that that are sold monthly or quarterly. Additionally or alternatively, some series may describe sales for products that are sold in thousands per week, while other series may describe sales for products that are sold much less frequently (e.g., one item per month).

In various examples, modeling accuracy for such time series can be improved significantly through the use of the segmented modeling approach described herein. Segmented modeling can use a combination of models that are trained on data series having different characteristics. For example, one model may be used to make predictions for time series that have a weekly seasonality (e.g., patterns in the time series repeat each week), and another model may be used to make predictions for time series that have a monthly seasonality. Additional models can be used to make predictions for other time series, such as zero-inflated time series and/or time series having extreme magnitudes.

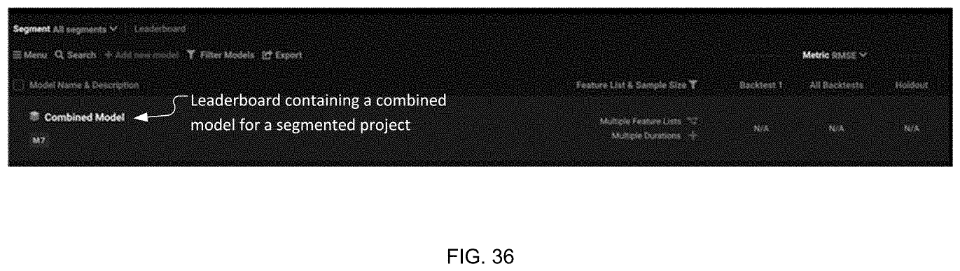

The multiple models used to model the time series in a dataset (or a portion or segment of a dataset) can be referred to herein as a combined model. The combined model can be a combination or collection of models for a dataset or segment. Referring to FIG. 36, when models for a segmented project have been identified and/or developed, a leaderboard for the project can identify a combined model, rather than providing a list of traditional models (e.g., as shown in FIG. 18).

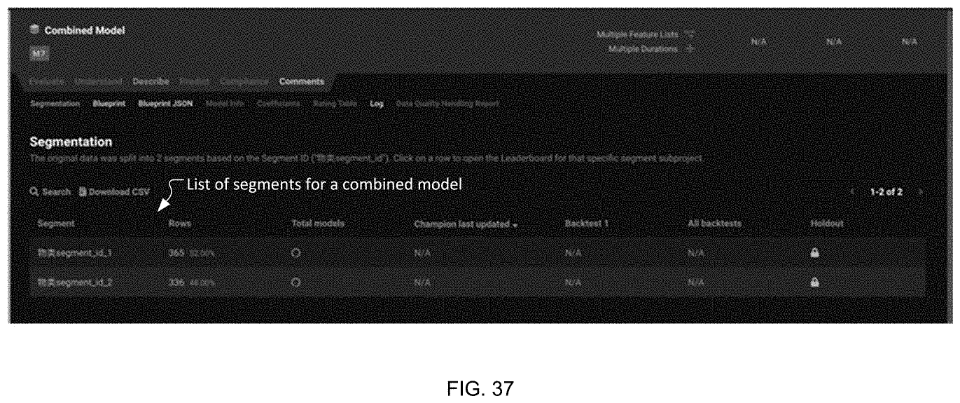

Additionally or alternatively, a combined model can be associated with one or more segments from a dataset. FIG. 37 includes a graphical user interface that presents segments and segment statuses for a combined model. The figure indicates that the combined model blends two segments together.

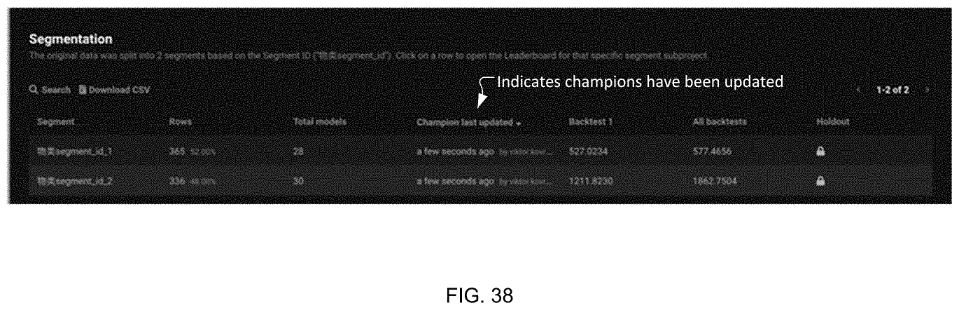

Models that are a part of combined model can be referred to as champions which, by default, can be the best models for the dataset or segment of the dataset. Users can drill down into each segment and change or specify the respective champion model. FIG. 38 shows segments for a combined model where champions have been updated.

In preferred implementations, combined models can act like a single model from the user's perspective. A user can upload a single dataset and the systems and methods described herein can automatically identify and develop a combined model for the dataset. The systems and methods can make predictions using the combined model and output prediction results for the combined model (e.g., as a single response).

### Additional Time Series Information

Many prediction problems pose the problem of predicting the values of one or more output variables (“targets”) at one or more future times based on the values of one or more input variables (“features”) at one or more past times. Such prediction problems may be referred to as “time-series prediction problems,” and predictive models that model such problems may be referred to as “time-series predictive models” or “time-series models.”

Techniques are needed for rigorously and efficiently exploring the modeling search space for time-series models. The inventors have recognized and appreciated that rigorous and efficient exploration of the time-series modeling search space (including efficient training, testing, and comparison of time-series models) can be facilitated by explicitly parametrizing certain aspects of time-series modeling procedures, for example, the amount of training data used to train the models, the time interval between observations of the input variables, the length of the time period covered by the training data, the recentness of the time period covered by the training data, the period of time (“skip range”) between the times associated with the feature values provided to the models (e.g., feature derivation window) and the times associated with the target values predicted by the models (e.g., forecast window), and the period of time (“forecast range” or forecast window) for which the models predict values of the targets.

In some embodiments, a predictive modeling system includes a time series model that can predict the values of a target X at time t and optionally t+1, . . . , t+i, given observations of X at times before t and optionally observations of other predictor variables P at times before t. In some embodiments, the predictive modeling system partitions past observations to train a supervised learning model, measure its performance, and improve accuracy. In some embodiments, the time series model provides useful time-related predictive features, for example, predicting previous values of the target at different lags. In some embodiments, the predictive modeling system refreshes the time series model as time moves forward and new observations arrive, taking into account the amount of new information in such observations and the cost of refitting the model.

An example illustrating a beneficial use of the time series model is now described. In this example, a supermarket chain wants to predict the next 6 weeks of daily sales for each of the supermarket's locations. The available data include the 3 years of previous daily sales data from 10,000 locations, plus other variables (e.g., population and economic growth around each location, historical and planned dates of holidays and major social events, and historical and planned dates of the chain's promotions). In some embodiments, a time series model trained on the available data can accurately predict the next 6 weeks of daily sales for each of the supermarket's locations.

Some embodiments of techniques for generating and using time series models are now described. When a data scientist develops a predictive modeling technique with a modeling technique builder, the data scientist may indicate that the modeling technique is specific to time series prediction problems. The modeling technique builder then encodes this characteristic in the modeling technique's metadata. Datasets themselves may also have time series specific metadata (e.g., the date range from which the data originated, temporal resolution of the observations, any down-sampling that has already occurred, etc.).

When a dataset is loaded, the systems and methods described herein may automatically detect whether the dataset appears to contain time series data and, if so, what the time index appears to be. A time index may include a time resolution and a time step (“time interval”). The time resolution is the unit in which time is kept (e.g., seconds or days). For example, if the dates (e.g., all the dates) are encoded in a standard date format (e.g., mm/dd/yyyy), the systems and methods may use days as the resolution. As another example, if the dates (e.g., all the dates) include hours, minutes, and seconds, the systems and methods may use seconds as the time resolution. Similarly, the systems and methods can use any suitable time metric (e.g., millennia, centuries, decades, years, quarters, seasons, months, weeks, days, hours, minutes, seconds, milliseconds, microseconds, nanoseconds, etc.) as a common time resolution. The time step is a time period (e.g., the smallest time period, the most typical time period, a user specified time period, etc.) between successive observations (e.g., daily, weekly, or annual data).

In cases where the dataset contains time series data with a mixture of time resolutions, the systems and methods may use the most common resolution as part of the time index, or use the “lowest common resolution” after converting all the time data to the common resolution. In some embodiments, the systems and methods may use an internal objective function that weights frequency and disparity of potential indexes to choose an index (e.g., the optimal index). For example, if 90% of the date variables are at day resolution and 10% are at a resolution of seconds, the objective function may determine that day resolution is the best choice. The reverse mixture (90% resolution of seconds, 10% day resolution) may yield a determination that a resolution of seconds is the best choice. At a 50% mix, the objective function may determine that compromising on a resolution between days and seconds (e.g., hours) is optimal. The choice of objective function may further be determined by meta-machine learning on the space of previously used objective functions and their accuracy for prediction problems with various characteristics.

In some cases, backtesting can be performed using a validation range (e.g., a backtest duration or time period) equal to the forecast range or a multiple (e.g., a logical multiple) of the forecast range (e.g., if the user has specified an unusually short forecast range).

For time series data, cross validation and holdout may be implemented with a set of training ranges, a set of corresponding validation ranges (e.g., backtests) offset by the skip range, and a holdout range. A default target number of training and validation ranges may be utilized and/or may be adjusted depending on the amount of data available. Datasets with relatively few time periods may be partitioned into fewer training and validation ranges while those with relatively many time periods may be partitioned into more training and validation ranges.

Depending on the size of the data, the frequency of the data, the length of the skip range, and/or the forecast range, lengths may be selected for training ranges. For example, with daily observations and the skip and forecast ranges expressed in weeks, months, or years (or corresponding multiples of days such as 7, 30, and 365), the engine may select training ranges of a whole number of weeks, months, or years. The length of these training windows may depend on the total number of observations, total amount of data, total amount of variation in target and predictor variables over time, the amount of seasonal variation exhibited by the variables, the consistency of variation in these variables over different time windows, and/or the target length of the forecast period. An internal objective function can be used that weights these factors to choose the length of the training windows (e.g., the optimal length). For example, the default may be 5 training and validation ranges (e.g., number of backtests) divided up evenly over the total dataset. However, if the amount of variation over longer time periods is low, the time windows may be shortened. Or, if there is annual seasonality in the data, only 3 windows may be used, thereby placing several years of data into each range. Or, if there are a few specific periods within the dataset that exhibit high variation, the data may be divided such that each window includes one of these periods. The choice of objective function may be determined by meta-machine learning on the space of previously used objective functions and their accuracy for prediction problems with various characteristics.

With the desired number of training and validation ranges and the length of these ranges plus the skip range, the dataset can be divided into a consistent series of training and validation ranges. For panel data (e.g., datasets containing a mixture of time-series and cross-sectional variables, or cross-sectionally down-sampled data), each training and validation pair can be further partitioned into folds (e.g., by randomly assigning sectional observations to a fold). In the supermarket example, the training range may be 30 weeks, the skip range 1 week, and the validation range 6 weeks, yielding approximately 4 training sets over 3 years. However, because there are 10,000 stores, these stores could further be “down-sampled” to improve performance. Sub-windows within the training and validation windows may be reserved and used for tuning model hyper-parameters and blended models.

In some embodiments, the holdout data is only in the last time window. However, if the dataset is panel data and has been down-sampled, the holdout data may be from the same time period as other data, but from a different, non-overlapping sample.

Training can be performed by iterating through the dataset, training each model on a small fraction of the training window, evaluating its performance on that fraction, then deciding whether to continue testing the model on additional data based on its performance. In the case of time series data, each fraction may end on the last observation in the training window, the initial fraction may start such that its fractional training window is a logical multiple of the validation window, and bigger fractions may use bigger multiples. For example, validation windows measured in weeks may use a first fraction starting 4 weeks before the end of the training window, a second fraction starting 8 weeks before, the third 12 weeks, etc. Validation windows measured in months may use a first fraction starting 3 months before the end of the training window, a second fraction starting 6 months before, the third 9 months, the fourth 12 months, etc. Validation windows measured in years may use a first fraction starting 4 years before the end of the training window, a second fraction starting 8 years before, the third 12 years; alternatively, the fractional periods may be 5, 10, and 15 years before the end of the training window. Fractions may increase linearly (e.g., 3, 6, 9, 12 periods or 4, 8, 12, 16 periods) or geometrically (e.g., 3, 6, 12, 24 periods or 4, 8, 16, 32 periods). Exponential increases in fractions are also possible (e.g., 3, 6, 24, 192 periods or 4, 8, 32, 256 periods), as are idiosyncratic schedules based on the problem domain and/or analysis of the data.

### Computer Implementations

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

FIG. 39 is a block diagram of an example computer system 3900 that may be used in implementing the technology described in this document. General-purpose computers, network appliances, mobile devices, or other electronic systems may also include at least portions of the system 3900. The system 3900 includes a processor 3910, a memory 3920, a storage device 3930, and an input/output device 3940. Each of the components 3910, 3920, 3930, and 3940 may be interconnected, for example, using a system bus 3950. The processor 3910 is capable of processing instructions for execution within the system 3900. In some implementations, the processor 3910 is a single-threaded processor. In some implementations, the processor 3910 is a multi-threaded processor. The processor 3910 is capable of processing instructions stored in the memory 3920 or on the storage device 3930.

The memory 3920 stores information within the system 3900. In some implementations, the memory 3920 is a non-transitory computer-readable medium. In some implementations, the memory 3920 is a volatile memory unit. In some implementations, the memory 3920 is a non-volatile memory unit.

The storage device 3930 is capable of providing mass storage for the system 3900. In some implementations, the storage device 3930 is a non-transitory computer-readable medium. In various different implementations, the storage device 3930 may include, for example, a hard disk device, an optical disk device, a solid-date drive, a flash drive, or some other large capacity storage device. For example, the storage device may store long-term data (e.g., database data, file system data, etc.). The input/output device 3940 provides input/output operations for the system 3900. In some implementations, the input/output device 3940 may include one or more of a network interface devices, e.g., an Ethernet card, a serial communication device, e.g., an RS-232 port, and/or a wireless interface device, e.g., an 802.11 card, a wireless modem (e.g., 3G, 4G, or 5G). In some implementations, the input/output device may include driver devices configured to receive input data and send output data to other input/output devices, e.g., keyboard, printer and display devices 3960. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 3930 may be implemented in a distributed way over a network, for example as a server farm or a set of widely distributed servers, or may be implemented in a single computing device.

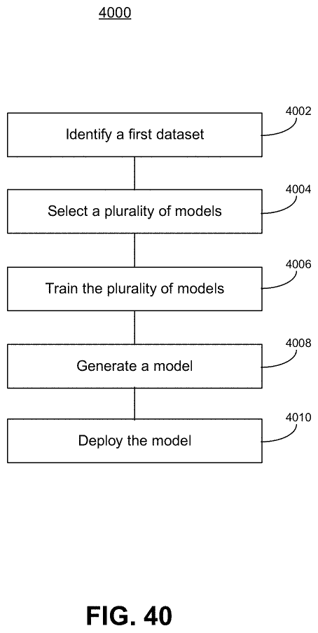

Referring now to FIG. 40, an example method 4000 of time series modeling is provided. The method 4000 can be performed by one or more system or component depicted here, including, for example, system 100 depicted in FIG. 1 or processing system 3900 depicted in FIG. 39. The method 4000 can be performed by one or more processors coupled to memory. The method 4000 can include identifying a first dataset at ACT 4002. For example, one or more processors can receive the first dataset from a user device or client device. The one or more processors can receive a reference or link or identifier to the first dataset, which can be stored in an online data repository or storage, such as a cloud storage system. The first dataset can be used as a training data set or be referred to as a training data set. The first dataset can include multiple time series that include multiple characteristics. The first dataset can include a first time series and a second time series. The first time series can include one or more characteristics that are different from all the characteristics of the second time series. For example, the first time series can include at least characteristic that is not included in the second time series. The first and second time series can include overlapping characteristics, but not the exact same combination of characteristics. In some cases, the first time series can include a characteristic, or a combination of characteristics, that no other time series in the first dataset includes. For example, no other time series in the first dataset may include one particular characteristic of the first dataset. In another example, no other time series in the first dataset may include the same combination of characteristics as the first dataset.

At ACT 4004, the method can include selecting multiple models. The one or more processors can select the models based on the characteristics of the first dataset. The one or more processors can select the models by mapping the characteristics of the time series of the first dataset. The one or more processors may perform a lookup in a table that maps characteristics to models.

At ACT 4006, the method 4000 includes training the multiple models. The one or more processors can train the multiple models using the training data, such as the first dataset. The one or more processors can train the multiple models using machine learning.

The method 4000 can include generate a model at ACT 4008. The one or more processors can generate a model that is a combination or based at least in part on a combination of the multiple models that were trained using the training data. The method 4000 can include deploying the model at ACT 4010. The one or more processors can deploy the model to output one or more predictions responsive to a second dataset or new data. The second data set or new data can be different from the training data or at least include some data that is different from the training data. The new data can have similar or some characteristics in common with the training data.

Although an example processing system has been described in FIG. 39, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, an engine, a pipeline, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A system, comprising:
one or more processors, coupled to memory, to:
identify a first dataset comprising a plurality of time series having a plurality of characteristics, wherein a first time series of the plurality of time series comprises one or more characteristics of the plurality of characteristics that are different from characteristics of a second time series of the plurality of time series;
select, based at least in part on the plurality of characteristics, a plurality of models;
train, via machine learning, the plurality of models with the first dataset;
generate a model based at least in part on a combination of the plurality of models; and
deploy the model to output one or more predictions responsive to a second dataset, different from the first dataset, having at least one of the plurality of characteristics.

2. The system of claim 1, wherein the one or more processors are further configured to:
determine that multiple rows in the first dataset comprise a same timestamp;
provide, responsive to the determination, a prompt via a graphical user interface displayed on a display device coupled to a computing device;
receive, via the prompt from the computing device, an indication that the first dataset comprises more than one time series; and
determine to select the plurality of models based at least in part on the indication received from the computing device.

3. The system of claim 1, wherein the one or more processors are further configured to:
provide, for display via a graphical user interface presented on a display device coupled to a computing device, a prompt to split the first dataset by segments;
receive, via the graphical user interface from the computing device, an indication to split the first dataset by segments; and
split, responsive to the indication, the first dataset into segments.

4. The system of claim 1, wherein the one or more processors are further configured to:
provide, via a graphical user interface presented by a display device of a computing device, a user interface element to adjust at least one of a first window used to derive one or more features from the first dataset or a second window over which to predict values for the one or more features.

5. The system of claim 4, wherein the one or more processors are further configured to:
provide, via the graphical user interface, an indication of a forecast point at or between the first window and the second window.

6. The system of claim 5, wherein the one or more processors are further configured to:
identify a blind history gap between the first window and the forecast point presented via the graphical user interface; and
provide an indication via the graphical user interface of the blind history gap.

7. The system of claim 5, wherein the one or more processors are further configured to:
identify, based at least on the forecast point and the second window, a gap for which the model is unable to make predictions.

8. The system of claim 1, wherein the one or more processors are further configured to:
provide, for presentation by a graphical user interface via a display device coupled to a computing device, a user interface element to select a configuration for a backtest;
receive, via the user interface element, a selection of the configuration for the backtest; and
provide, for presentation by the graphical user interface, an indication of at least one of a validation portion for the backtest, a primary training data portion for the backtest, a gap for the backtest, or a holdout portion for the backtest.

9. The system of claim 1, wherein the one or more processors are further configured to:
provide, for presentation by a graphical user interface via a display device coupled to a computing device, a user interface element to input a calendar of events to generate a feature for the plurality of time series;
receive, via the user interface element, the calendar of events; and
derive one or more features of the first dataset using the calendar of events.

10. The system of claim 1, wherein the plurality of characteristics comprise at least one of seasonality, frequency content, average target values, maximum target values, minimum target values, or a number of zero values.

11. The system of claim 1, wherein the one or more processors are further configured to:
map each time series in the plurality of time series to at least one model in the plurality of models to select the plurality of models.

12. The system of claim 11, wherein the one or more processors are further configured to:
cluster the time series in the plurality of time series into a plurality of groups, wherein each group in the plurality of groups comprises common or similar characteristics from the characteristics; and
assign each group to a respective model from the plurality of models to select the plurality of models.

13. A method, comprising:
identifying, by one or more processors coupled to memory, a first dataset comprising a plurality of time series having a plurality of characteristics, wherein a first time series of the plurality of time series comprises one or more characteristics of the plurality of characteristics that are different from characteristics of a second time series of the plurality of time series;
selecting, by the one or more processors based at least in part on the plurality of characteristics, a plurality of models;
training, by the one or more processors via machine learning, the plurality of models with the first dataset;
generating, by the one or more processors, a model based at least in part on a combination of the plurality of models; and
deploying, by the one or more processors, the model to output one or more predictions responsive to a second dataset, different from the first dataset, having at least one of the plurality of characteristics.

14. The method of claim 13, comprising:
determining, by the one or more processors, that multiple rows in the first dataset comprise a same timestamp;
providing, by the one or more processors responsive to the determination, a prompt via a graphical user interface displayed on a display device coupled to a computing device;
receiving, by the one or more processors via the prompt from the computing device, an indication that the first dataset comprises more than one time series; and
determining, by the one or more processors, to select the plurality of models based at least in part on the indication received from the computing device.

15. The method of claim 13, comprising:
providing, by the one or more processors, for display via a graphical user interface presented on a display device coupled to a computing device, a prompt to split the first dataset by segments;
receiving, by the one or more processors via the graphical user interface from the computing device, an indication to split the first dataset by segments; and
splitting, by the one or more processors responsive to the indication, the first dataset into segments.

16. The method of claim 13, comprising:
providing, by the one or more processors via a graphical user interface presented by a display device of a computing device, a user interface element to adjust at least one of a first window used to derive one or more features from the first dataset or a second window over which to predict values for the one or more features.

17. The method of claim 16, comprising:
providing, by the one or more processors via the graphical user interface, an indication of a forecast point at or between the first window and the second window.

18. The method of claim 13, comprising:
providing, by the one or more processors, for presentation by a graphical user interface via a display device coupled to a computing device, a user interface element to select a configuration for a backtest;
receiving, by the one or more processors via the user interface element, a selection of the configuration for the backtest; and
providing, by the one or more processors, for presentation by the graphical user interface, an indication of at least one of a validation portion for the backtest, a primary training data portion for the backtest, a gap for the backtest, or a holdout portion for the backtest.

19. A non-transitory computer-readable medium storing processor executable instructions that, when executed by one or more processors, cause the one or more processors to:
identify a first dataset comprising a plurality of time series having a plurality of characteristics, wherein a first time series of the plurality of time series comprises one or more characteristics of the plurality of characteristics that are different from characteristics of a second time series of the plurality of time series;
select, based at least in part on the plurality of characteristics, a plurality of models;
train, via machine learning, the plurality of models with the first dataset;
generate a model based at least in part on a combination of the plurality of models; and
deploy the model to output one or more predictions responsive to a second dataset, different from the first dataset, having at least one of the plurality of characteristics.

20. The computer-readable medium of claim 19, wherein the instructions further comprise instructions to:
determine that multiple rows in the first dataset comprise a same timestamp;
provide, responsive to the determination, a prompt via a graphical user interface displayed on a display device coupled to a computing device;
receive, via the prompt from the computing device, an indication that the first dataset comprises more than one time series; and
determine to select the plurality of models based at least in part on the indication received from the computing device.
